(19) United States
(12) Patent Application Publication
(10) Pub. No.: US 2013/0205193 A1
(43) Pub. Date: Aug. 8, 2013

(54) WEB PAGE CONTROL METHOD, COMPUTER SYSTEM AND PROGRAM

(71) Applicants: Kaho Matsufuji, Yokohama (JP); Masaru Iwashita, Yokohama (JP)

(72) Inventors: Kaho Matsufuji, Yokohama (JP); Masaru Iwashita, Yokohama (JP)

(73) Assignee: Hitachi, Ltd.

(21) Appl. No.: 13/642,013

(22) PCT Filed: Apr. 30, 2010
(86) PCT No.: PCT/JP2010/057982

§ 371 Date: Dec. 31, 2012

(51) Int. Cl. G06F 17/21

(52) U.S. Cl. CPC G06F 17/211
USPC 715/234

(57) ABSTRACT

A web page control method of integrating, by a computer, a plurality of web pages and outputting the plurality of web pages as a single web page, the web page control method including: acquiring, by the computer, integration definition information for defining the plurality of web pages to be integrated into the single web page; extracting, an input/output relationship between components included in the plurality of web pages of the integration definition information; extracting, a component of the web page being an output destination from the extracted input/output relationship; prohibiting, an operation from being performed on the extracted component being the output destination; extracting, all components of the web page being input sources from the extracted input/output relationship; and permitting, the operation to be performed on the component being the output destination when the operation has been completed on all the components of the web page being the input sources.

### BACKGROUND OF THE INVENTION

This invention relates to a web page display control method, a web application system, and a program, in particular, a web page display control method, a web application system, and a program for integrating a plurality of web pages based on a dependence relationship between the web pages.

In recent years, introduction of an IT system that aims at an increase in task efficiency of an operator (user) who uses a plurality of IT systems to perform a task is in progress. For example, Japanese Patent Application Laid-open No. 2009-246589 discloses a call center assisting system for assisting an operator in efficiently conducting a task by presenting the operator with a procedure for the task or a procedure for using the IT systems. Specifically, in the call center assisting system, a flowchart display area for displaying a plurality of jobs forming a task in an order in which the jobs are to be carried out by the operator and a job assisting information display area for displaying information necessary for the operator to carry out the job are combined into a single screen and displayed for each job.

A developer develops each screen to be displayed for the operator by assuming an information amount required on the screen by the operator. However, there may be an alienation between the information amount assumed by the developer and an information amount expected by the operator, and the developed IT system may not always provide ease of use to the operator. In other words, in a case where information having a smaller amount than expected by the operator is displayed on the screen, the operator must perform a larger number of operations than expected in order to obtain information having an amount corresponding to the expected information amount.

On the other hand, when information previously displayed on a plurality of screens is displayed on a single screen, the information having a larger amount than expected by the operator is displayed, and hence there occurs such a burden that the operator must find his/her necessary information from the information displayed on the screen. Such an operation hinders the operator from smoothly conducting a task.

Against such a backdrop, Japanese Patent Application Laid-open No. 2002-312391 exemplifies a method of changing an amount of information to be displayed on a single screen to suit the operator's need. Japanese Patent Application Laid-open No. 2002-312391 discloses a method of integrating a plurality of web pages designated by the operator into a single screen to be displayed thereon, which allows the operator himself/herself to partially select information to be displayed on the screen from within the respective web pages. The use of the technology disclosed in Japanese Patent Application Laid-open No. 2002-312391 enables the screens of the plurality of web pages designated by the operator to be integrated into a single screen and displayed thereon, which allows the operator to change the amount of information to be displayed on the single screen to suit the operator's need.

### SUMMARY OF THE INVENTION

However, the above-mentioned technology disclosed in the Japanese Patent Application Laid-open No. 2002-312391 has a problem in that control cannot be performed based on a dependence relationship between web pages displayed on a single screen, which causes inconsistency in processing in a case where contents of the respective web pages are determined based on a sequence of jobs to be carried out by an operator.

For example, consideration is given to a system having such a dependence relationship that a specific item is input on one web page while a range of a value to be input to an item to be displayed on another web page is limited based on the input to the specific item. Originally, the two web pages are not displayed on the same screen at different timings or at the same time, and hence, with regard to an input item of the another web page, the dependence relationship between the two items, in other words, the range of the value to be input to the item is determined based on an input value of the item input on the previous web page. For this reason, even when the operator inputs a value exceeding a limitation to the item of the another web page, it is possible to dynamically detect an input error. In the case of integrating those two web pages into a single screen to be displayed thereon, the technology disclosed in Japanese Patent Application Laid-open No. 2002-312391 simply integrates the two screens based on a user's settings, but cannot determine the dependence relationship between the input items of the two pages. In other words, on the screen obtained by integration by the technology disclosed in Japanese Patent Application Laid-open No. 2002-312391, the operator can ignore a sequence for inputting the respective items to previously input a value outside the range (to an item corresponding to the item of the above-mentioned another web page), which leads to a problem of causing inconsistency in the data.

In addition, in the above-mentioned technology disclosed in Japanese Patent Application Laid-open No. 2002-312391, in a case where a plurality of web pages are simply integrated and simultaneously displayed on the same screen, duplicate information displayed in common on the respective web pages are displayed, which leads to another problem of deterioration in visibility of information.

In order to solve the above-mentioned problems, it is necessary to prevent the inconsistency in processing ascribable to the integration of the screens performed by the operator and the deterioration in the visibility of the information and to assist the operator in efficiently conducting a task reliably.

In order to solve the above-mentioned problems, this invention provides a web page control method of integrating, by a computer, a plurality of web pages and outputting the plurality of web pages as a single web page, the web page control method including: a first step of acquiring, by the computer, integration definition information for defining the plurality of web pages to be integrated into the single web page; a second step of extracting, by the computer, an input/output relationship between components included in the plurality of web pages of the integration definition information; a third step of extracting, by the computer, a component of the web page being an output destination from the extracted input/output relationship; a fourth step of prohibiting, by the computer, an operation from being performed on the extracted component of the web page being the output destination; a fifth step of extracting, by the computer, all components of the web page being input sources from the extracted input/output relationship; and a sixth step of permitting, by the computer, the operation to be performed on the component of the web page being the output destination when the operation has been completed on all the components of the web page being the input sources.

In addition, the web page control method further includes a step of comparing history information on inputs/outputs between the component of the web page being the input source of the extracted input/output relationship and the component of the web page being the output destination thereof, and deleting the component of the web page being the output destination for which comparison results thereof are constantly the same.

This invention produces an effect of an increase in convenience in the single web page obtained by integrating the plurality of web pages having the dependence relationship as the input/output relationship between the components. By controlling inputs to the components to be displayed on the respective web pages after the integration based on the input/output relationship between the components included in the web pages, it is possible to prevent the user from performing the inputs in a wrong sequence, and hence it is possible to assist the user in conducting a task reliably. In addition, by deleting duplicate components, it is possible to increase visibility of the information to be displayed within the single web page.

In addition, according to this invention, the information amount of the single screen can be changed by using the web page developed by the developer in advance, which facilitates the development of the web page that suits the information amount expected by the user.

### BRIEF DESCRIPTION OF THE DRAWINGS

FIG. 1A is a block diagram mainly illustrating a client apparatus according to a first embodiment of this invention.

FIG. 1B is a block diagrams mainly illustrating a server apparatus according to the first embodiment of this invention.

FIG. 2 illustrates an example of a structure of a flow definition information table according to the first embodiment of this invention.

FIG. 3 illustrates an example of a structure of a step integration definition information table according to the first embodiment of this invention.

FIG. 4 illustrates an example of a structure of a change field storage table according to the first embodiment of this invention.

FIG. 5 illustrates an example of a structure of an input/output history information table according to the first embodiment of this invention.

FIG. 6 illustrates a description example of the flow definition information according to the first embodiment of this invention.

FIG. 7A is a flowchart of the first part illustrating an example of processing for changing the flow definition information according to the first embodiment of this invention.

FIG. 7B is a flowchart of the last part illustrating an example of processing for changing the flow definition information according to the first embodiment of this invention.

FIG. 8A is a flowchart of the first part illustrating an example of input item control processing according to the first embodiment of this invention.

FIG. 8B is a flowchart of the last part illustrating an example of input item control processing according to the first embodiment of this invention.

FIG. 9A is a flowchart of the first part illustrating an example of duplication deletion processing according to the first embodiment of this invention.

FIG. 9B is a flowchart of the second part illustrating an example of duplication deletion processing according to the first embodiment of this invention.

FIG. 9C is a flowchart of the last part illustrating an example of duplication deletion processing according to the first embodiment of this invention.

FIG. 10 is a flowchart illustrating an example of step integration processing according to the first embodiment of this invention.

FIG. 11A is a flowchart of the first part illustrating an example of an event listener processing according to the first embodiment of this invention.

FIG. 11B is a flowchart of the second part illustrating an example of the event listener processing according to the first embodiment of this invention.

FIG. 11C is a flowchart of the last part illustrating an example of the event listener processing according to the first embodiment of this invention.

FIG. 12A illustrates a display format of the task flow in a case where the task steps are not integrated according to the first embodiment of this invention.

FIG. 12B illustrates a display format of the task flow in a case where the task steps are integrated according to the first embodiment of this invention.

FIG. 13 illustrates an example of an integration screen obtained in a case where the integrated task step includes a repetition definition according to the first embodiment of this invention.

FIG. 14 illustrates an example of an integration screen obtained in a case where the integrated task step includes a condition branch according to the first embodiment of this invention.

FIG. 15 is a block diagram illustrating outlines of hardware and software of a computer system according to a second embodiment of this invention.

FIG. 16 illustrates an example of a structure of a group management table according to the second embodiment of this invention.

FIG. 17 is a block diagram illustrating an outline of hardware and software of a computer system according to a third embodiment of this invention.

### DETAILED DESCRIPTION OF THE PREFERRED EMBODIMENTS

A description is made below of embodiments of this invention with reference to the accompanying drawings.

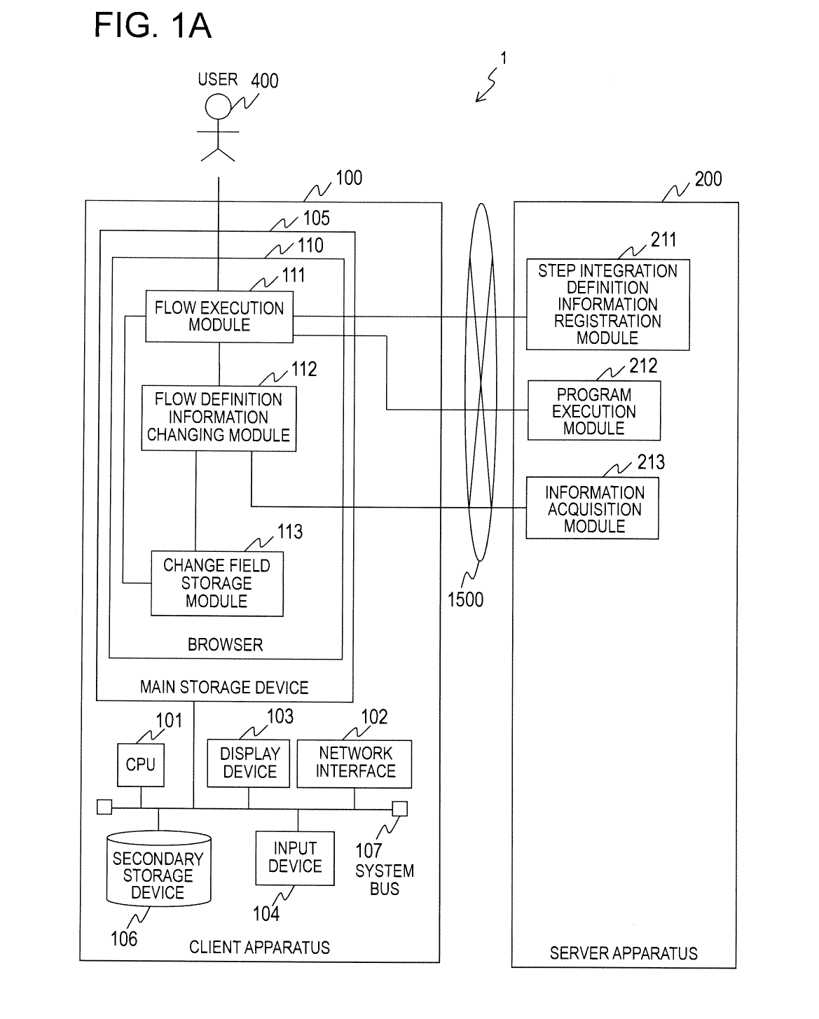

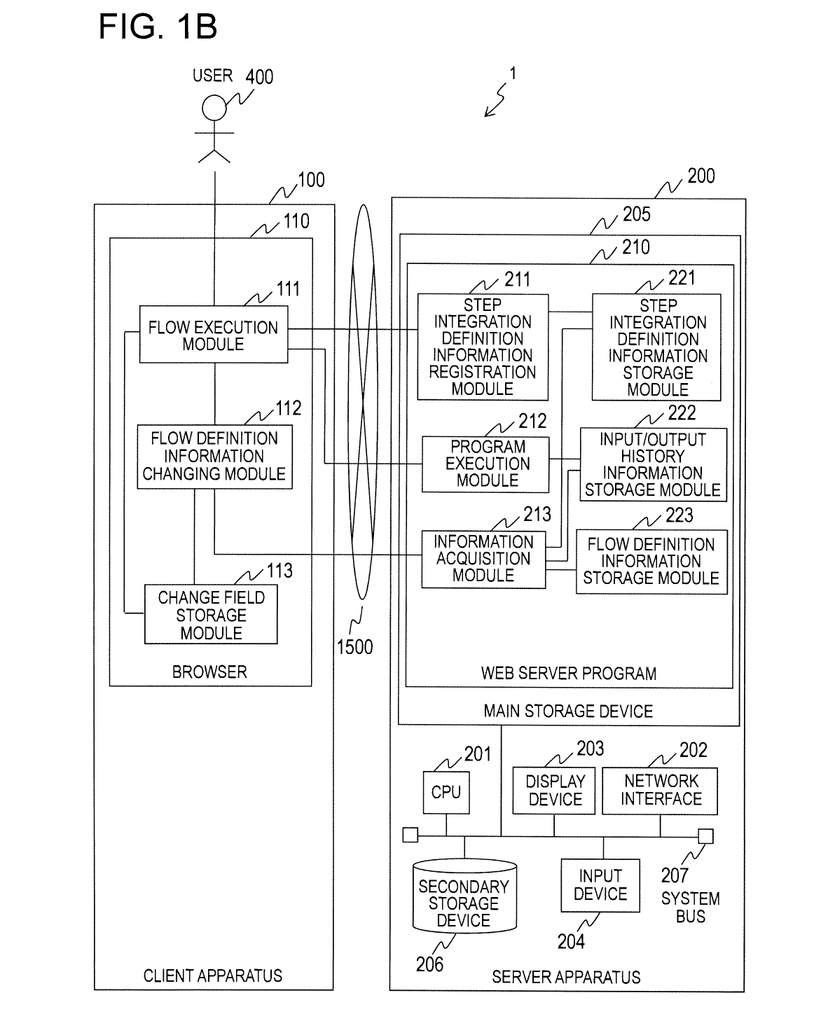

FIGS. 1A and 1B are block diagrams illustrating outlines of hardware and software of a computer system 1 according to a first embodiment to which this invention is applied. FIG. 1A is the block diagram mainly illustrating a client apparatus 100. FIG. 1B is the block diagram mainly illustrating a server apparatus 200.

The computer system 1 is configured as a web application system in which the client apparatus 100 and the server apparatus 200 are coupled to each other via a network 1500 and a user (operator) 400 can be provided with a predetermined task application service by operating the client apparatus e 100 to perform communications to/from the server apparatus 200. The server apparatus 200 provides the task application service as a task flow in response to a request from the client apparatus 100. It should be noted that the task flow in this embodiment is formed of a plurality of task steps, for example, a task flow for placing an order of a product is formed of the plurality of task steps including a task step of inputting an ID of the product, a task step of displaying an inventory of the product, and a task step of inputting a quantity of the product. The respective task steps are formed of mutually independent web pages.

In this embodiment, information for integrating a plurality of web pages into one web page is previously set for each user of the client apparatus 100, and when receiving a request to execute the task flow, the client apparatus 100 and the server apparatus 200 execute processing for integrating the plurality of task steps into a single web page and outputting the single web page.

First described is a configuration of the client apparatus 100.

In FIG. 1A, the client apparatus 100 is realized by a general-purpose computer, and includes a CPU 101, a network interface 102, a display device 103, an input device 104, a main storage device 105, a secondary storage device 106, and a system bus 107 for coupling those components to one another.

The network interface 102 performs communications to/from the server apparatus 200 and the like coupled thereto via the network 1500 in accordance with an instruction from the CPU 101. It should be noted that FIGS. 1A and 1B are illustrated so that functional blocks described later are directly coupled to each other in order to clarify a relationship between the functional blocks, but the functional blocks are coupled to each other via the network interface 102 on an occasion of actual processing.

The display device 103 processes an image to be displayed on an image display device such as a display. The input device 104 has a function of receiving the user's input through a device such as a mouse or a keyboard.

A browser 110 is stored on the main storage device 105, and is executed in accordance with the instruction from the CPU 101. The secondary storage device 106 inputs/outputs data in accordance with the instruction from the CPU 101. The main storage device 105 is a volatile storage device such as a memory. The secondary storage device 106 is a storage device to which various nonvolatile storage media are applicable, such as a magnetic storage device including a hard disk drive or an optical storage device including a CD or DVD drive. It should be noted that the secondary storage device 106 functions as a storage medium for a program such as a browser described later.

The browser 110 can transmit a hypertext transfer protocol (HTTP) request to the server apparatus 200 in response to a request made by the user 400, acquire content data managed by the server apparatus 200 by receiving an HTTP response including data such as text and images from the server apparatus 200, and display the content data on the display device 103. Here, the browser 110 is a general application program for displaying web content on the Internet, and hence a detailed description thereof is omitted. A flow execution module 111, a flow definition information changing module 112, and a change field storage module 113 function on the browser 110. Those modules are described below as processing modules implemented in a programming language such as JavaScript (trademark), but are not limited thereto.

The flow execution module 111 has a function of calling the flow definition information changing module 112 based on the request made by the user 400, receiving flow definition information described in a language such as an extensible markup language (XML), and converting the received flow definition information into HTML data, to thereby execute the task flow, and performs processing for calling a step integration definition information registration module 211 and a program execution module 212, which are described later, in response to the request made by the user 400. It should be noted that a method of converting the flow definition information into HTML data to execute the task flow, which is performed by the flow execution module 111, can be realized by a well-known or publicly-known technology, and hence a detailed description thereof is omitted here. It should be noted that when receiving a change request to combine the task steps or the like from the user 400, the flow execution module 111 notifies the server apparatus 200 of information on the task steps changed by the user 400.

The flow definition information changing module 112 acquires the flow definition information, step integration definition information, and input/output history information from an information acquisition module 213 of the server apparatus 200 based on the request made by the flow execution module 111, changes a flow definition based on the acquired information, and returns a result of the changing to the flow execution module 111. In addition, the flow definition information changing module 112 registers the information on the flow definition changed as described above in the change field storage module 113. A structure of the flow definition information and processing for changing the flow definition are described later.

The change field storage module 113 stores information relating to a field included in the task flow whose definition is changed by the flow definition information changing module 112 at a time of the processing for changing the flow definition, in a change field storage table 520 in association with input/output definition information. A structure of the flow definition information and structures of field definition information and the input/output definition information that are included in the flow definition information are described later. Further, the change field storage table 520 exists in the change field storage module 113, and is stored in the main storage device 105 or the secondary storage device 106.

Next, FIG. 1B illustrates a configuration of the server apparatus 200. In the same manner as in the client apparatus 100, the server apparatus 200 is realized by a general-purpose computer, and includes a CPU 201, a network interface 202, a display device 203, an input device 204, a main storage device 205, a secondary storage device 206, and a system bus 207 for coupling those components to one another. Individual hardware functions thereof are the same as those of the client apparatus 100, and hence detailed descriptions thereof are omitted. The server apparatus 200 is different from the client apparatus 100 in that the program stored on the main storage device 205 and executed by the CPU 201 is a web server program 210. It should be noted that the secondary storage device 206 functions as a storage medium for storing the web server program 210.

Next, the server apparatus 200 includes the web server program 210 that is ready to receive the HTTP request issued by the browser 110 or the like at all times and, when receiving the HTTP request, returns document data designated by the HTTP request as the HTTP response. Further, in this embodiment, the web server program 210 includes the step integration definition information registration module 211, the program execution module 212, the information acquisition module 213, a step integration definition information storage module 221, an input/output history information storage module 222, and a flow definition information storage module 223.

The step integration definition information registration module 211 receives the information on the task steps to be integrated (or combined) based on an instruction from the user 400 through the request made by the flow execution module 111, and stores the information in the step integration definition information storage module 221. In other words, the step integration definition information storage module 221 is notified of a flow ID of the task flow including the task steps whose integration has been instructed by the user 400 and a set of step IDs, and the step integration definition information storage module 221 stores the flow ID, the set of the step IDs, and a user ID in a step integration definition information table 510 in association with one another. A structure of the step integration definition information table 510 is described later. It should be noted that the step integration definition information table 510 exists in the step integration definition information storage module 221, and is stored in the main storage device 205 or the secondary storage device 206.

The program execution module 212 provides the task application service by executing the program designated by the flow execution module 111 based on the request made by the flow execution module 111 and received from the client apparatus 100, and registers history information on the executed program in the input/output history information storage module 222.

Based on the request made by the flow definition information changing module 112 of the client apparatus 100, the information acquisition module 213 acquires flow definition information 502 from the flow definition information storage module 223, acquires the step integration definition information from the step integration definition information storage module 221, extracts the input/output history information from the input/output history information storage module 222, and sends a response to the flow definition information changing module 112.

Based on the request made by the step integration definition information registration module 211, the step integration definition information storage module 221 stores step integration definition information 513 relating to the task steps to be integrated in the step integration definition information table 510 in association with the flow ID and the user ID. Further, the step integration definition information storage module 221 extracts the information relating to the task steps to be integrated based on the request made by the information acquisition module 213. The structure of the step integration definition information table 510 is described later.

The input/output history information storage module 222 stores input/output data handled by the program executed by the program execution module 212 in an input/output history information table 530 in association with the flow ID and a field ID. Further, the input/output history information storage module 222 extracts the information relating to the input/output data based on the request made by the information acquisition module 213. A structure of the input/output history information table 530 is described later. It should be noted that the input/output history information table 530 exists in the input/output history information storage module 222, and is stored in the main storage device 205 or the secondary storage device 206.

Based on the request made by the information acquisition module 213, the flow definition information storage module 223 extracts the flow definition information from a flow definition information table 500 in which the flow ID and the flow definition information are stored in association with each other. A structure of the flow definition information table 500 is described later. It should be noted that in this embodiment, data stored in the flow definition information table 500 is defined in advance. It should be noted that the flow definition information table 500 exists in the flow definition information storage module 223, and is stored in the main storage device 205 or the secondary storage device 206.

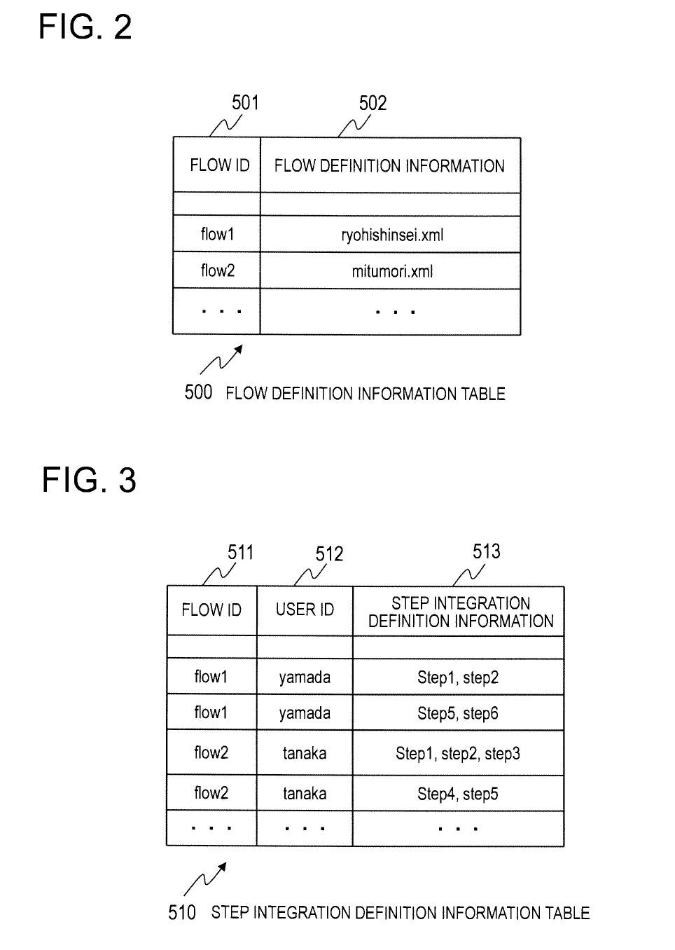

FIG. 2 illustrates an example of the structure of the flow definition information table 500. The flow definition information table 500 is formed of a column 501 for storing the flow ID of the task flow and a column 502 for storing the flow definition information, and the column 502 stores the flow definition information that can be uniquely identified by the flow ID stored in the column 501.

Specifically, it is indicated that the flow definition information that can be uniquely identified by the flow ID of “flow1” is “ryohishinsei.xml” and that the flow definition information that can be uniquely identified by the flow ID of “flow2” is “mitumori.xml”.

FIG. 3 illustrates an example of the structure of the step integration definition information table 510. The step integration definition information table 510 is formed of a column 511 representing the flow ID of the task flow, a column 512 representing the user ID, and a column 513 representing the step integration definition information. The step integration definition information table 510 indicates, with regard to a flow corresponding to the flow ID stored in the column 511, that the user 400 having the user ID stored in the column 512 has instructed to integrate the steps stored in the column 513.

Specifically, it is indicated, with regard to the flow definition information uniquely identified by the flow ID of “flow1”, that the user 400 having the user ID of “yamada” has instructed to integrate the task steps having “step1” and “step2” as IDs of the task steps defined by the flow definition information and to integrate the task steps having “step5” and “step6” as the IDs. Further, it is indicated, with regard to the flow definition information uniquely identified by the flow ID of “flow2”, that the user 400 having the user ID of “tanaka” has instructed to integrate the task steps having “step1”, “step2”, and “step3” as the IDs defined by the flow definition information and to integrate the task steps having “step4” and “step5” as the IDs.

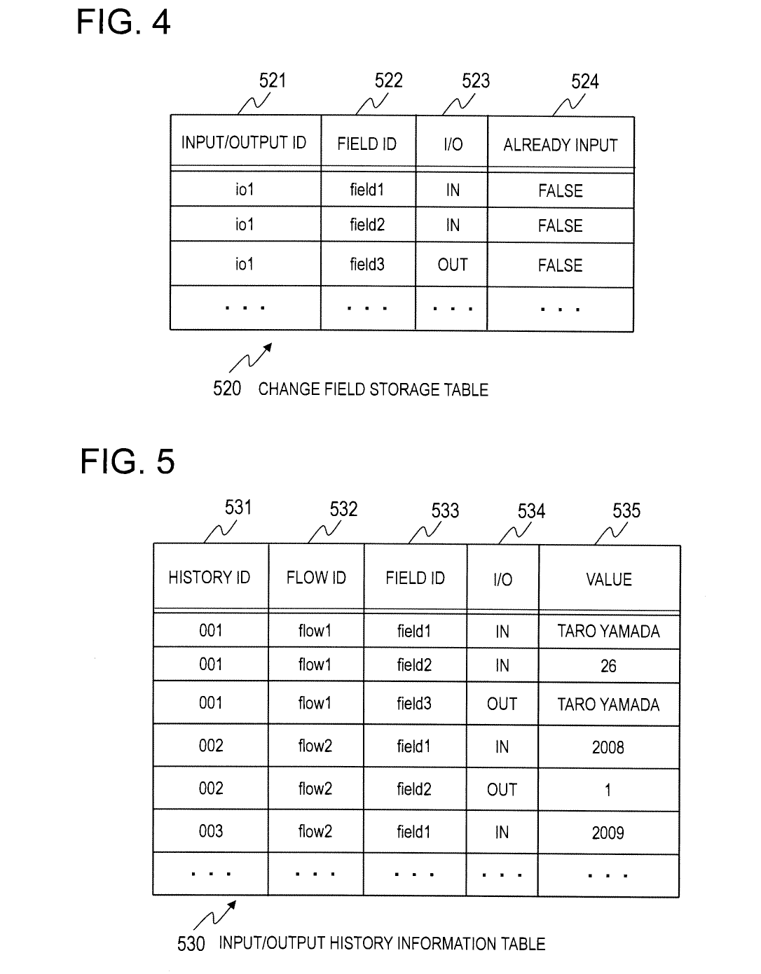

FIG. 4 illustrates an example of the structure of the change field storage table 520. The change field storage table 520 is formed of a column 521 for storing an input/output ID, a column 522 for storing the field ID, a column 523 for storing an input/output flag, and a column 524 for storing whether or not an input has already been performed.

With regard to the input/output definition information having the input/output ID as the ID defined by the flow definition information (502), the flow definition information changing module 112 identifies a field forming the input/output definition information by the field ID, identifies whether or not a field representing the field ID is included in input definition information and whether or not the field is included in output definition information by the column 523, and further identifies whether or not the field has been input by the user 400 by the column 524.

It should be noted that the column 523 of the change field storage table 520 represents the input definition information if having a value of “IN”, and represents the output definition information if having a value of “OUT”. Further, the column 524 of the change field storage table 520 indicates, if having a value of “FALSE”, that a field corresponding to a field ID 522 has not been input yet, and indicates, if having a value of “TRUE”, that the field corresponding to the field ID 522 has already been input. Specifically, it is indicated, with regard to the input/output definition information having “io1” as the input/output ID, that fields having “field1” and “field2” as the field ID are defined as the input definition information that has not been input yet and that a field having “field3” as the field ID is defined as the output definition information that has not been input yet.

FIG. 5 illustrates an example of the structure of the input/output history information table 530. The input/output history information table 530 is formed of a column 531 for storing a history ID, a column 532 for storing the flow ID, a column 533 for storing the field ID, a column 534 for storing the input/output flag, and a column 535 for storing the input/output data handled by the program. Each time the program execution module 212 executes a program, the input/output data handled by the program is stored in the column 535. It should be noted that the column 531 is a column for storing an ID that can uniquely identify an execution history of the program performed by the program execution module 212. Further, in the same manner as in the column 523, the column 534 has a value indicating which of the input definition information and the output definition information the field corresponding to the field ID is. Specifically, the history ID “001” indicates a history of execution of a task flow having the flow ID of “flow1” in which a value of “TARO YAMADA” was input to the field having the field ID of “field1” and a value of “26” was input to the field having the field ID of “field2” to call the program. The history ID “001” further indicates the history in which a value of “TARO YAMADA” was output to the field having a resultant field ID of “field3” as a result of the above-mentioned inputs. Further, the history ID “002” indicates a history of execution of a task flow having the flow ID of “flow2” in which a value of “2008” was input to the field having the field ID of “field1” to execute the program and a value of “1” was output to the field having “field2” as the resultant field ID corresponding to the input.

It should be noted that expressions of data structures of the tables illustrated in FIGS. 2 to 5 are merely examples, and do not limit other expressions of the data structures.

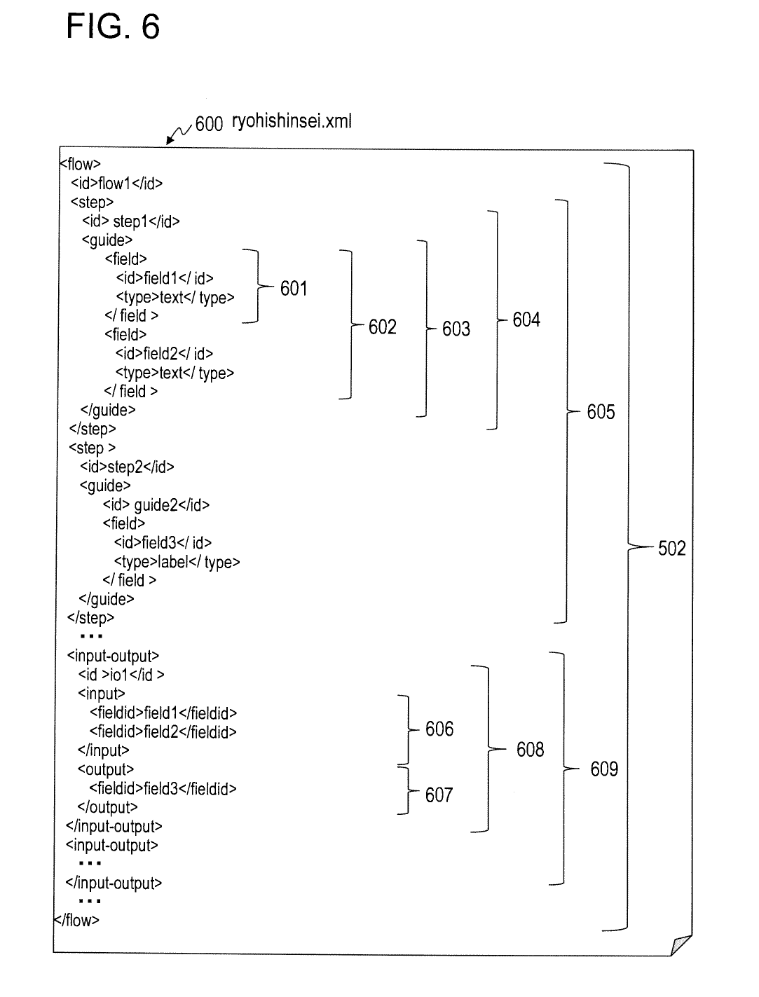

FIG. 6 illustrates a description example of the flow definition information 502. It should be noted that in this embodiment, the flow definition information 502 is described in an XML format, but this invention is not limited thereto. The flow definition information 502 has a flow element <flow> as a root element. The flow element has an id element <id> as a child element, and a value of the id element represents the flow ID for uniquely identifying the flow definition information 502. In addition, the flow element has a step definition information group 605 and an input/output definition information group 609 as child elements.

The step definition information group 605 is a set of information pieces representing the task steps forming the task flow. Here, the task step defines information corresponding to a unit of an HTML page in a case where the flow execution module 111 converts the flow definition information 502 into HTML data and presents the HTML data to the user 400 (display device 103). The step definition information group 605 is formed of at least one piece of step definition information 604, and each piece of step definition information 604 is defined by step elements. Each of the step elements has the id element as the child element, and the value of the id element represents the step ID for uniquely identifying the step definition information 604. Further, the step definition information 604 has guide definition information 603 that is defined by a guide element.

The guide definition information 603 is converted into a component of the HTML data by the flow execution module 111, and defines information to be output to a screen of the display device 103. The guide definition information 603 is formed of a field definition information group 602, and the field definition information group 602 is formed of at least one piece of field definition information 601. Here, the field represents an individual element of the HTML data converted by the flow execution module 111. The field definition information 601 is defined by a field element, and the value of the id element being the child element represents the field ID for uniquely identifying the field definition information 601. Further defined is an HTML element to be converted by a type element.

The input/output definition information group 609 is a set of information pieces for defining the program to be called in a case where the flow execution module 111 causes the task step to transition based on the instruction from the user 400, and is formed of at least zero piece of input/output definition information 608. The input/output definition information 608 is defined by an input-output element. The input-output element has the id element as the child element, and the value of the id element represents the input/output ID that can uniquely identify the input/output definition information 608. Further, the input-output element has at least zero piece of input definition information 606 and at least zero piece of output definition information 607 as the child elements. However, the number of pieces of input definition information 606 and the number of pieces of output definition information 607 cannot be zero simultaneously. Each of the pieces of input definition information 606 is defined by an input element, and the input element has a fieldid element defining the field ID indicating input data within the input/output definition information 608. Further, each of the pieces of output definition information 607 is defined by an output element, and the output element has a fieldid element defining the field ID for storing an output data within the input/output definition information 608.

The example of FIG. 6 shows a part of the flow definition information 502 whose id is flow1, and indicates that the flow includes the step definition information 604 whose id is step1 and step2 and the input/output definition information whose id is io1.

The task step whose id is step1 includes the field definition information 601 whose id is field1 and the field definition information whose id is field2 as the guide definition information 603, and those fields are defined as text input fields because of having the type element of “text”. Further, the task step whose id is step2 includes field definition information 601 whose id is field3 as the guide definition information 603, and the field is defined as a character string field because of having the type element of “label”.

It should be noted that definition contents of the type element are merely examples, and are not limited to those values. Further, the conversion into the HTML element is not limited to the text input field or a character string element, and definitions corresponding to any kind of HTML element are made possible by uniquely defining the conversion into the HTML element.

The input/output definition information 608 whose id is io1 includes the fieldid elements having the values of field1 and field2 as the input definition information 606, which defines that the values input in the fields whose field IDs are field1 and field2 are used as the input of io1. Further, the fieldid element having the value of field3 as the output definition information 607 is included, which defines that the output data of io1 is output to the field whose field ID is field3.

It should be noted that the definition of the flow in an XML format is merely an example, and does not limit other definition methods.

The following description is made mainly by taking the above-mentioned respective processing modules provided by the CPU 101 of the client apparatus 100 or the CPU 201 of the server apparatus 200 executing the program. Further, in the following description, data storing a plurality of variables is expressed as a array, but this invention is not limited thereto, and any other data structure that stores the plurality of variables as one piece of data may be used.

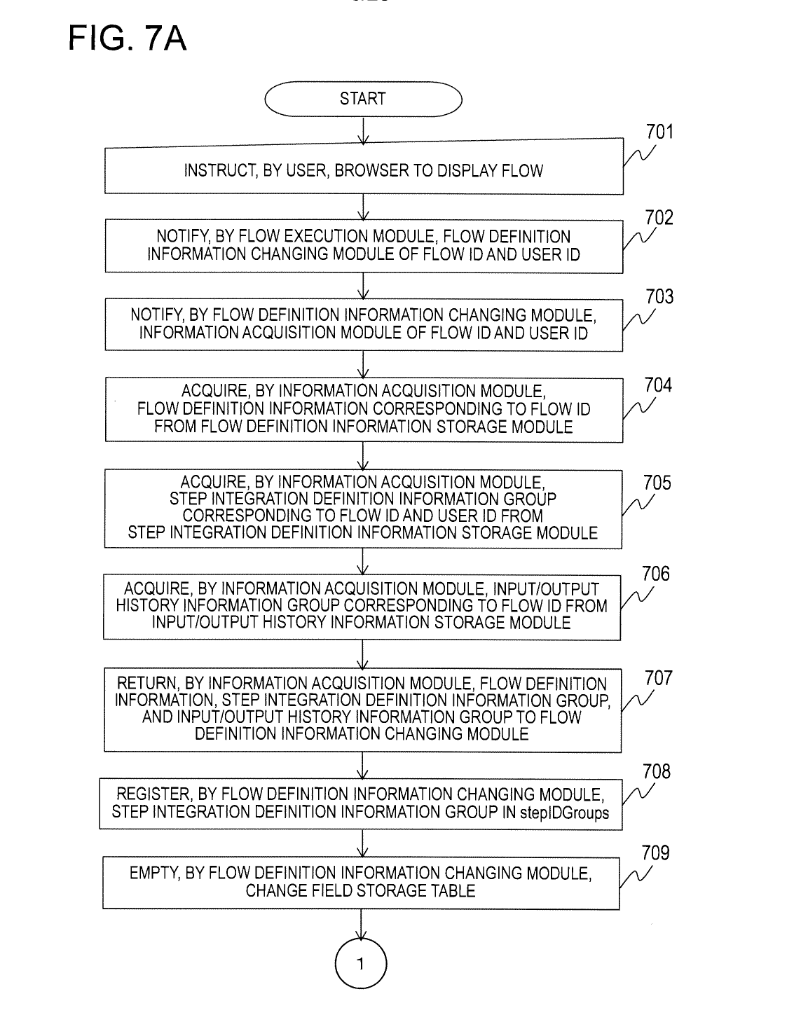

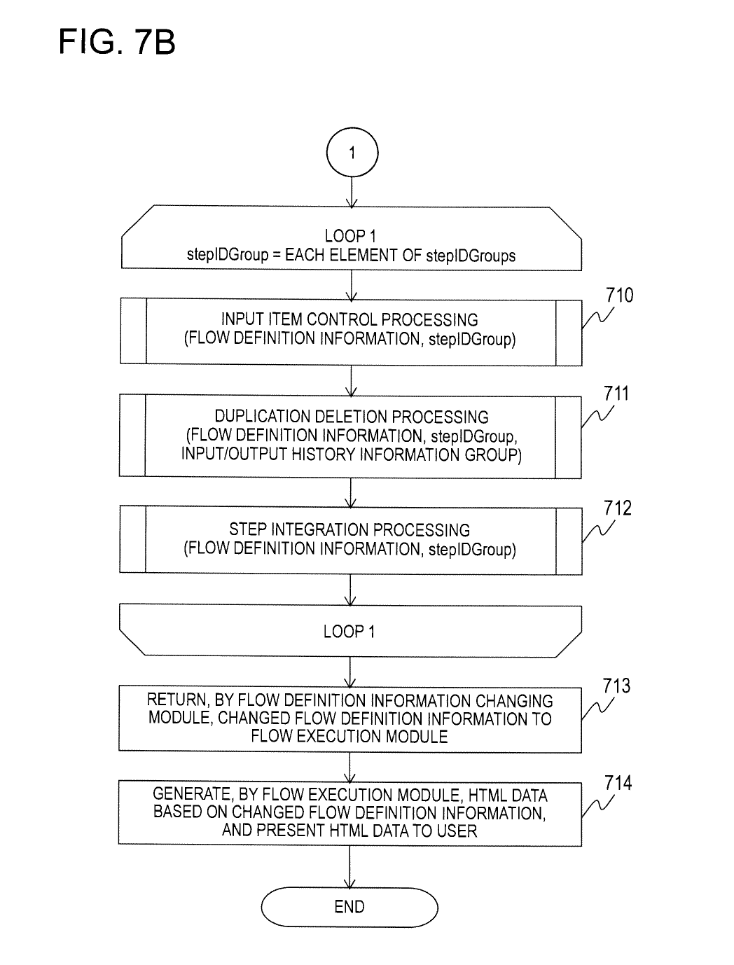

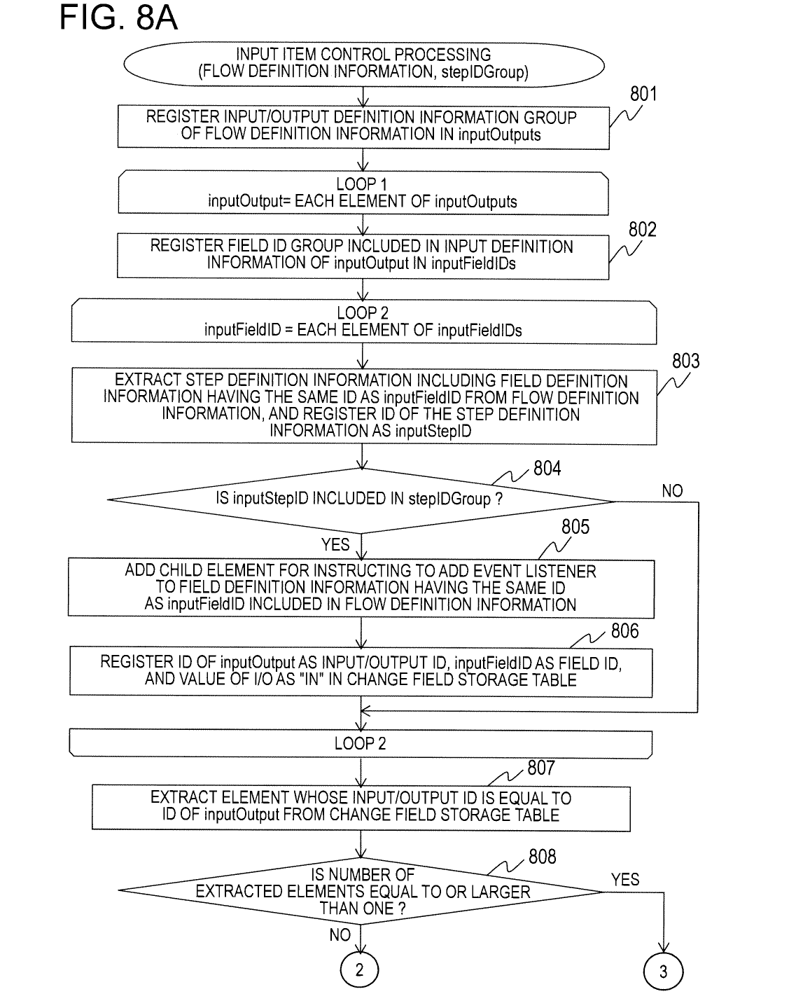

FIGS. 7A and 7B are flowcharts illustrating an example of processing for changing the flow definition information 502 according to this embodiment. This processing is executed by the browser 110 of the client apparatus 100 by being triggered by an operation performed by the user 400.

In this embodiment, Step 701 of instructing, by the user 400, the browser 110 to display the task flow is first executed.

The flow execution module 111 notifies the flow definition information changing module 112 of the flow ID for identifying the task flow specified by the user 400 and the user ID for identifying the user 400 (Step 702). It should be noted that the user 400 notifies the flow execution module 111 of the user ID in advance.

The flow definition information changing module 112 notifies the information acquisition module 213 of the server apparatus 200 of the flow ID and the user ID that have been received (Step 703).

The information acquisition module 213 requests the flow definition information storage module 223 to perform a search using the flow ID received from the flow definition information changing module 112 as a key, and acquires the flow definition information 502 corresponding thereto (Step 704). At this time, the flow definition information storage module 223 acquires the flow definition information 502 of the column 502 from a row whose column 501 has a value matching the received flow ID within the flow definition information table 500, and returns the flow definition information 502 to the information acquisition module 213.

Subsequently, the information acquisition module 213 requests the step integration definition information storage module 221 to perform a search using the flow ID and the user ID that have been received from the flow definition information changing module 112 as keys, and acquires a step integration definition information group corresponding thereto (Step 705). At this time, the step integration definition information storage module 221 acquires the step integration definition information of the column 513 from all rows whose column 511 has a value matching the received flow ID and whose column 512 has a value matching the received user ID within the step integration definition information table 510, and returns the step integration definition information to the information acquisition module 213.

In addition, the information acquisition module 213 requests the input/output history information storage module 222 to perform a search using the flow ID received from the flow definition information changing module 112 as a key, and acquires an input/output history information group corresponding thereto (Step 706). At this time, the input/output history information storage module 222 refers to the input/output history information table 530 to acquire the history ID of the column 531, the field ID of the column 533, the input/output flag of the column 534, and the input/output data of the column 535 from all rows whose column 532 has a value matching the received flow ID, and returns the history ID, the field ID, the input/output flag, and the input/output data to the information acquisition module 213.

The information acquisition module 213 returns the flow definition information 502, the step integration definition information group, and the input/output history information group that have been acquired in Steps 704, 705, and 706, respectively, to the flow definition information changing module 112 (Step 707).

The flow definition information changing module 112 of the client apparatus 100, which has received a response from the information acquisition module 213, registers the received step integration definition information group in a preset array stepIDGroups (Step 708).

The flow definition information changing module 112 empties the change field storage table 520 (Step 709).

Subsequently, the flow definition information changing module 112 repeats the following processing by assuming each element of the array stepIDGroups as stepIDGroup (Loop 1).

The flow definition information changing module 112 calls input item control processing 800 by using the flow definition information 502 received from the information acquisition module 213 and a variable stepIDGroup as arguments (Step 710). Contents of the input item control processing 800 are described later.

Subsequently, the flow definition information changing module 112 calls duplication deletion processing 900 by using the flow definition information 502, the variable stepIDGroup, and the input/output history information group that have been received from the information acquisition module 213 as the arguments (Step 711). Contents of the duplication deletion processing 900 are described later.

In addition, the flow definition information changing module 112 calls step integration processing 1000 by using the flow definition information 502 received from the information acquisition module 213 and the variable stepIDGroup as the arguments (Step 712). Contents of the step integration processing 1000 are described later.

After completing the above-mentioned Loop 1, the flow definition information changing module 112 returns the flow definition information 502 changed in the above-mentioned Loop 1 to the flow execution module 111 (Step 713).

The flow execution module 111 generates HTML data based on the flow definition information 502 returned by the flow definition information changing module 112, and outputs the HTML data to the display device 103 (Step 714).

According to the above-mentioned processing, the plurality of task steps designated by the user 400 are output to the display device 103 as a single web page, which enables the user 400 to conduct the task flow in a desired display mode.

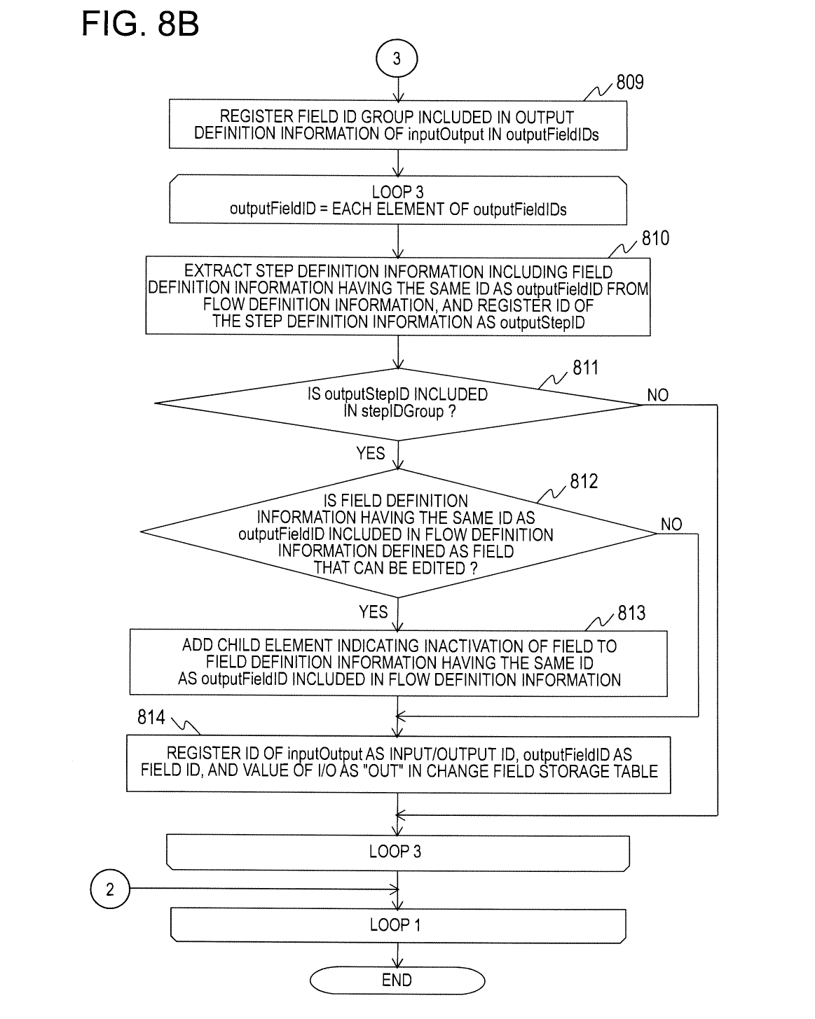

FIGS. 8A and 8B are flowcharts illustrating an example of input item control processing according to this embodiment. This processing represents a subroutine of the processing performed in Step 710 of FIG. 7B.

First, the flow definition information changing module 112 extracts the input/output definition information group from the flow definition information 502, and registers the input/output definition information group in a preset array inputOutputs (Step 801).

The flow definition information changing module 112 repeats the following processing by assuming each element registered in the array inputOutputs as inputOutput (Loop 1).

The flow definition information changing module 112 extracts the input definition information included in a variable inputOutput, and registers values of all the fieldid elements included in the extracted input definition information in a array inputFieldIDs (Step 802).

The flow definition information changing module 112 repeats the following processing by assuming each element registered in the array inputFieldIDs as inputFieldID (Loop 2).

The flow definition information changing module 112 extracts the field definition information 601 including the id element having the same value as a variable inputFieldID from the flow definition information 502, further extracts the step definition information 604 including the field definition information 601, and registers the step ID of the step definition information 604 as a variable inputStepID (Step 803).

The flow definition information changing module 112 determines whether or not the variable inputStepID is a value included in the variable stepIDGroup (Step 804). It should be noted that in this embodiment, the step IDs are registered in the variable stepIDGroup in a comma-delimited manner, and the variable inputStepID included in the variable stepIDGroup means that the variable inputStepID matches any one of the step IDs registered in a comma-delimited manner. When the variable inputStepID is included in the variable stepIDGroup (Step 804: Yes), the procedure advances to Step 805 described below, and when the variable inputStepID is not included in the variable stepIDGroup (Step 804: No), the processing of Step 803 is repeated by changing the variable stepIDGroup to the next element of the array stepIDGroups.

The flow definition information changing module 112 extracts the field definition information 601 including the id element having the same value as the variable inputFieldID from the flow definition information 502, and adds the child element for instructing to add a definition of an event listener to the field definition information 601 (Step 805). The event listener added here detects that the user 400 has completed an input operation in the HTML data converted from the field definition information 601, and calls event listener processing described later.

The flow definition information changing module 112 requests the change field storage module 113 to register the value of the id element of the variable inputOutput and the value of the variable inputFieldID (Step 806). At this time, the change field storage module 113 registers the received value of the id element of the variable inputOutput as the value of the column 521, the received value of the variable inputFieldID as the value of the column 522, the value of the column 523 as “IN”, and the value of the column 524 as “FALSE” in the change field storage table 520.

After executing the above-mentioned processing (Loop 2) on all the elements included in the array inputFieldIDs, the flow definition information changing module 112 requests the change field storage module 113 to perform a search using the value of the id element of the variable inputOutput as a key, and receives the number of corresponding elements (Step 807). At this time, the change field storage module 113 extracts all the elements in which the received value of the id element of the variable inputOutput matches the value of the column 521 from the change field storage table 520, and returns the number of extracted elements to the flow definition information changing module 112.

The flow definition information changing module 112 determines whether or not the number of elements received in Step 807 is equal to or larger than one (Step 808). When the number of elements is equal to or larger than one (Step 808: Yes), the procedure advances to Step 809, and when the number of elements is zero (Step 808: No), the procedure advances to Step 802 by changing the variable inputOutput to the next element of the array inputOutputs.

The flow definition information changing module 112 extracts the output definition information included in the variable inputOutput, and registers the values of all the fieldid elements included in the extracted output definition information in a array outputFieldIDs (Step 809).

The flow definition information changing module 112 executes the following processing by assuming each element included in the array outputFieldIDs as outputFieldID (Loop 3).

The flow definition information changing module 112 extracts the field definition information 601 including the id element having the same value as a variable outputFieldID from the flow definition information 502, further extracts the step definition information 604 including the field definition information 601, and registers the step ID of the step definition information 604 as a variable outputStepID (Step 810).

The flow definition information changing module 112 determines whether or not the variable outputStepID is a value included in the variable stepIDGroup (Step 811). When the variable outputStepID is included in the variable stepIDGroup (Step 811: Yes), the procedure advances to Step 812, and when the variable outputStepID is not included in the variable stepIDGroup (Step 811: No), the procedure advances to Step 810 by changing the variable outputFieldID to the next element of the array outputFieldIDs.

The flow definition information changing module 112 extracts the field definition information 601 including the id element having the same value as the variable outputStepID from the flow definition information 502, and determines whether or not the field definition information 601 is to be converted as an element that can be edited in the case of being converted into the HTML data (Step 812). It should be noted that whether or not to be converted as the element that can be edited can be determined from the value of a type attribute included in the field definition information 601. For example, when the value of the type attribute is “text”, the field definition information 601 is to be converted into the text input field, and hence the flow definition information changing module 112 determines that the field definition information 601 is to be converted as the element that can be edited. On the other hand, when the type attribute included in the field definition information 601 is “label”, the field definition information 601 is to be converted into the character string field, and hence the flow definition information changing module 112 determines that the field definition information 601 is not to be converted as the element that can be edited. When the field definition information 601 represents the element that can be edited (Step 812: Yes), the procedure advances to Step 813, and when the field definition information 601 is not the element that can be edited (Step 812: No), the procedure advances to Step 814.

The flow definition information changing module 112 extracts the field definition information 601 including the id element having the same value as the variable outputStepID from the flow definition information 502, and adds the child element indicating inactivation of the field to the field definition information 601 (Step 813). The child element indicating the inactivation can be expressed by, for example, adding a disable element as the child element of the field element and setting the value to “true”. The field that can be edited to which the child element indicating the inactivation is added prohibits the user 400 from performing the input until the disable element is changed to “false” or the element is deleted.

The flow definition information changing module 112 requests the change field storage module 113 to register the value of the id element of the variable inputOutput and the value of the variable outputFiledID (Step 814). At this time, the change field storage module 113 registers the received value of the id element of the variable inputOutput as the value of the column 521, the received value of outputFiledID as the value of the column 522, the value of the column 523 as “OUT”, and the value of the column 524 as “FALSE” in the change field storage table 520.

The flow definition information changing module 112 executes the above-mentioned processing (Loop 3) on all the elements included in the array outputFieldIDs, further executes the above-mentioned processing (Loop 1) on all the elements included in the array inputOutputs, and brings the input item control processing to an end.

According to the above-mentioned processing, with regard to the task step (web page) of an application program service provided by the server apparatus 200, when receiving the request to execute the task flow from the user 400, the client apparatus 100 refers to the step integration definition information table 510 to identify the web page for combining the plurality of task steps into one. The client apparatus 100 and the server apparatus 200 extract an input/output relationship between components (fields) included in the task steps to be integrated, extract the component of the task step to be an output destination from the extracted input/output relationship, and inhibit an operation from being performed on the extracted component of the task step to be the output destination which can be edited.

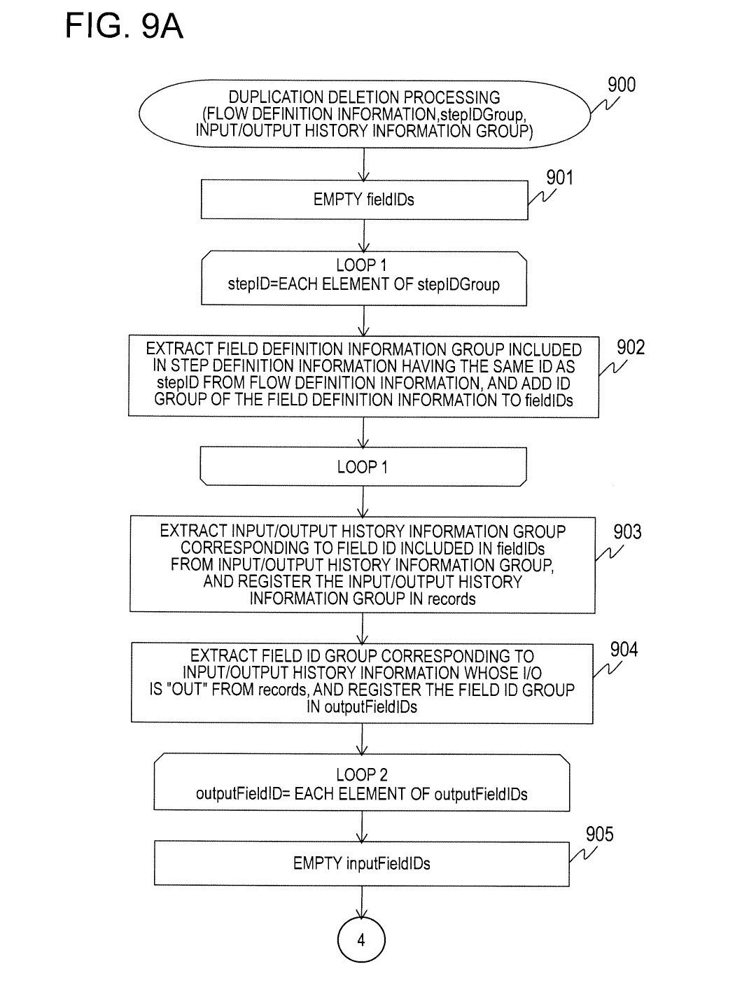

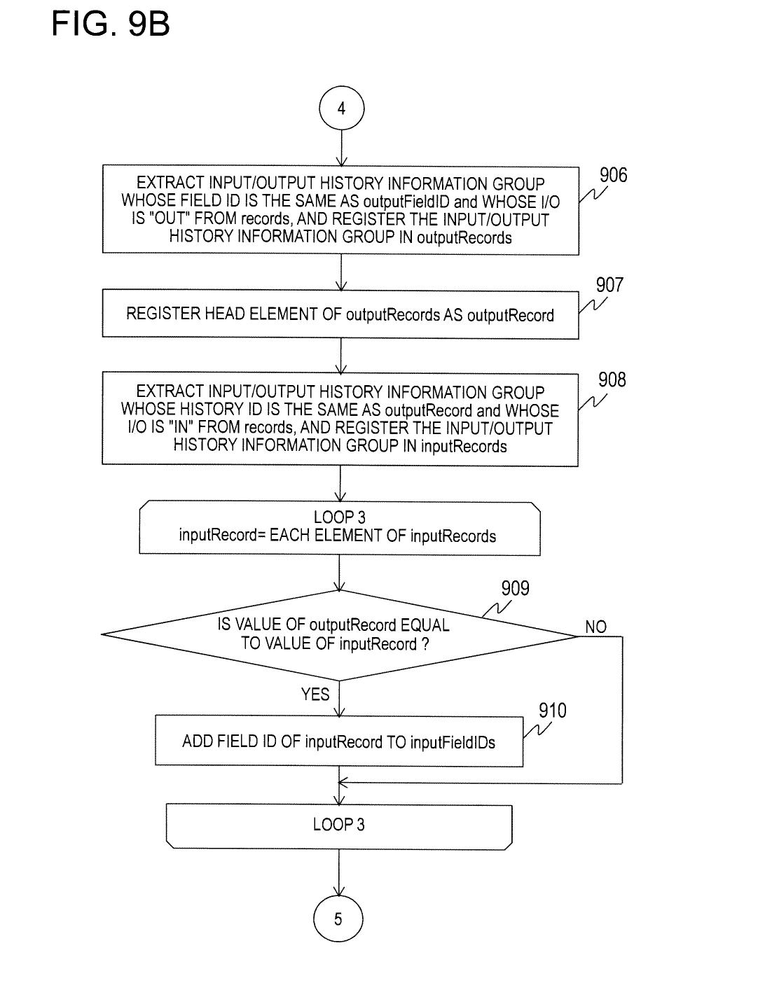

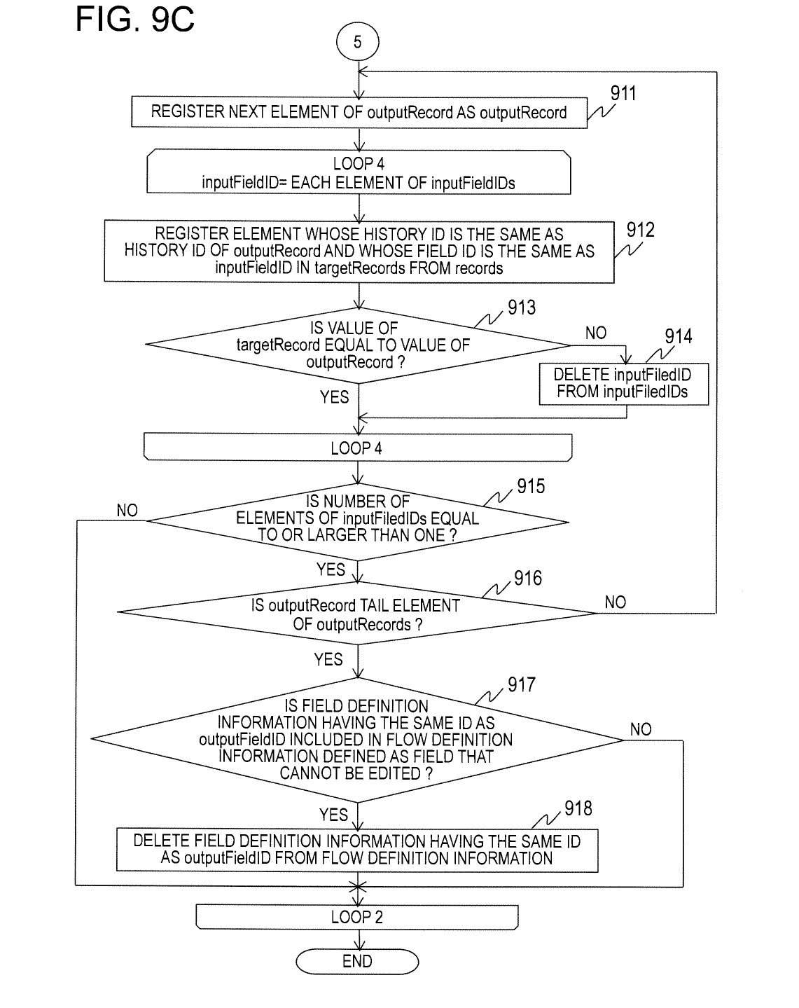

FIGS. 9A, 9B, and 9C are an example of duplication deletion processing according to this embodiment, which is expressed in the form of flowcharts. This processing represents a subroutine of the processing performed in Step 711 of FIG. 7B.

The flow definition information changing module 112 empties a preset array fieldIDs (Step 901).

The flow definition information changing module 112 executes the following processing by assuming each element of the variable stepIDGroup received as an input as stepID (Loop 1).

The flow definition information changing module 112 extracts the step definition information 604 including the id element having the same value as a variable stepID from the flow definition information 502, and extracts the field definition information group 602 included in the step definition information 604. The flow definition information changing module 112 extracts the value of the field ID from the field definition information 601 included in all the extracted pieces of the field definition information group 602, and adds the value to the array fieldIDs (Step 902).

After executing the above-mentioned processing (Loop 1) on each element of the variable stepIDGroup, the flow definition information changing module 112 extracts all pieces of input/output history information in which the value of the field ID extracted from the column 533 of the input/output history information group matches the value of the field ID included in the array fieldIDs, and registers all the pieces of input/output history information in a preset array records (Step 903).

The flow definition information changing module 112 searches the array records to extract the field ID of the input/output history information in which the input/output flag extracted from the column 534 of the input/output history information table 530 is “OUT”, and registers the field ID in the array outputFieldIDs (Step 904).

The flow definition information changing module 112 executes the following processing by assuming each element included in the array outputFieldIDs as outputFieldID (Loop 2).

The flow definition information changing module 112 empties the array inputFieldIDs (Step 905).

The flow definition information changing module 112 extracts all pieces of input/output history information whose field IDs have a value matching the variable outputFieldID and whose input/output flags are “OUT” from the array records, and registers all the pieces of input/output history information in a preset array outputRecords (Step 906).

The flow definition information changing module 112 registers the head element of the array outputRecords as a variable outputRecord (Step 907).

The flow definition information changing module 112 extracts all pieces of input/output history information whose history IDs have the same value as the value of the history ID of the variable outputRecord and whose input/output flags are “IN” from the array records, and registers all the pieces of input/output history information in the array inputRecords (Step 908).

The flow definition information changing module 112 executes the following processing by assuming each element included in a array inputRecords as inputRecord (Loop 3).

The flow definition information changing module 112 executes Step 909 of determining whether or not the value of the input/output data of the variable outputRecord matches the value of the input/output data of a variable inputRecord, and when the values match each other, the procedure advances to Step 910. On the other hand, when the value of the input/output data of the variable outputRecord does not match the value of the input/output data of the variable inputRecord, the determination of Step 909 is repeated by changing the variable inputRecord to the next value of the array inputRecords.

The flow definition information changing module 112 adds the value of the field ID of the variable inputRecord to the array inputFieldIDs (Step 910).

After executing the above-mentioned processing (Loop 3) on all the elements included in the array inputRecords, the flow definition information changing module 112 registers the next element of the variable outputRecord included in the array outputRecords as a new variable outputRecord (Step 911).

The flow definition information changing module 112 executes the following processing by assuming each element included in the array inputFieldIDs as inputFieldID (Loop 4).

The flow definition information changing module 112 registers all the elements whose history ID matches the history ID of the variable outputRecord and whose field ID matches the variable inputFieldID in a preset array targetRecords from the array records (Step 912).

The flow definition information changing module 112 determines whether or not the value of the input/output data of a variable targetRecord matches the value of the input/output data of the variable outputRecord (Step 913). When the values match each other (Step 913: Yes), the procedure advances to Step 912 by changing the variable inputFieldID to the next element of the array inputFieldIDs, and when the values do not match each other (Step 913: No), the procedure advances to Step 914.

The flow definition information changing module 112 deletes the value of the variable inputFieldID from the array inputFiledIDs (Step 914).

After executing the above-mentioned processing (Loop 4) on each element included in the array inputFieldIDs, the flow definition information changing module 112 determines whether or not the number of elements of the array inputFieldIDs is equal to or larger than one (Step 915). When the number of elements is equal to or larger than one (Step 915: Yes), the procedure advances to Step 916, and when the number of elements is zero (Step 915: No), the procedure advances to Step 905 being a start point of Loop 2 by changing the variable outputFieldID to the next element of the array outputFieldIDs.

The flow definition information changing module 112 determines whether or not the variable outputRecord is the tail element of the array outputRecords (Step 916). When the variable outputRecord is the tail element (Step 916: Yes), the procedure advances to Step 917, and when the variable outputRecord is not the tail element (Step 916: No), the procedure advances to Step 911.

The flow definition information changing module 112 extracts the field definition information 601 having the same id element as the variable outputFieldID from the flow definition information 502, and determines whether or not the field definition information 601 is to be converted as an element that cannot be edited in the case of being converted into the HTML data (Step 917). When the field definition information 601 indicates the element that cannot be edited (Step 917: Yes), the procedure advances to Step 918, and when the field definition information 601 does not indicate the element that cannot be edited (Step 917: No), the procedure advances to Step 905 being the start point of Loop 2 by changing the variable outputFieldID to the next element of the array outputFieldIDs.

The flow definition information changing module 112 extracts the field definition information 601 having the same id element as the variable outputFieldID from the flow definition information 502, and deletes the field definition information 601 from the flow definition information 502 (Step 918).

After executing the above-mentioned processing (Loop 2) on each element included in the array outputFieldIDs, the flow definition information changing module 112 brings the duplication deletion processing to an end.

According to the above-mentioned duplication deletion processing, the component (field) of the task step being an input source of the input/output relationship is compared with the history information on inputs/outputs of the component of the task step being the output destination, and the component of the task step being the output destination for which comparison results thereof are constantly the same is deleted, which can prevent the same components from being displayed in the task step obtained after integration.

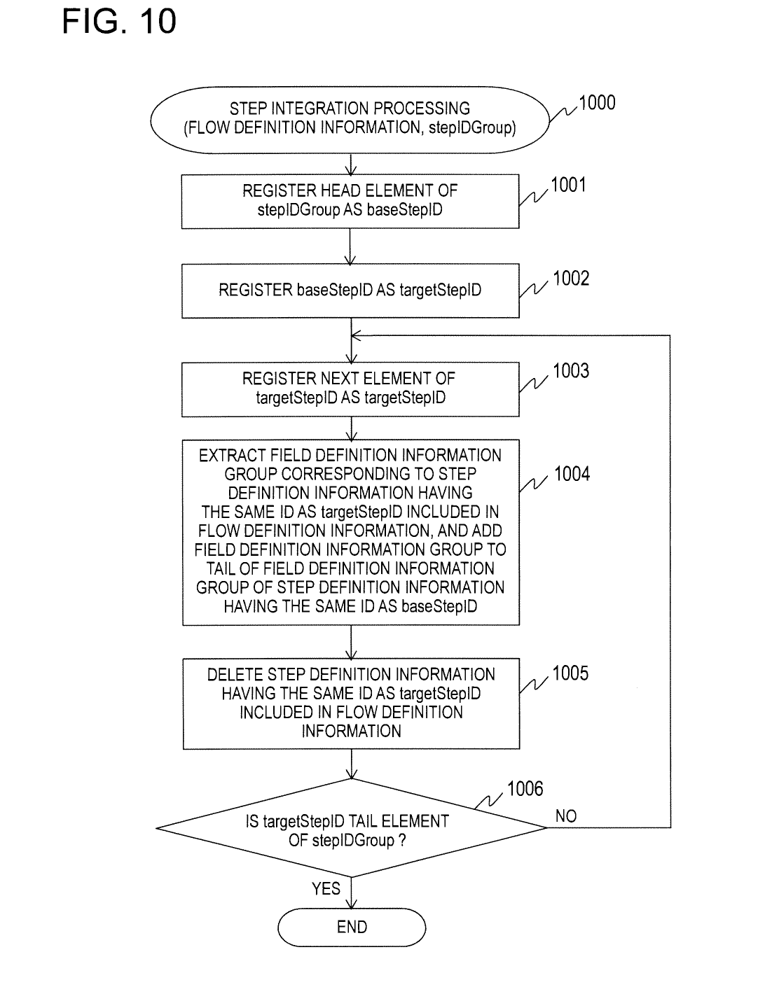

FIG. 10 is an example of step integration processing according to this embodiment, which is expressed in the form of a flowchart. This processing is a subroutine of the processing performed in Step 712 of FIG. 7B.

The flow definition information changing module 112 registers the head element of the variable stepIDGroup as baseStepID (Step 1001).

The flow definition information changing module 112 registers a variable baseStepID as a variable targetStepID (Step 1002).

The flow definition information changing module 112 registers the next element of the variable targetStepID within the variable stepIDGroup as a new variable targetStepID (Step 1003).

The flow definition information changing module 112 extracts the step definition information 604 including the id element having the same value as the variable targetStepID from the flow definition information 502, extracts all the pieces of field definition information 601 included in the step definition information 604, and adds all the pieces of field definition information 601 to the tail of the field definition information group 602 included in the step definition information 604 including the id element having the same value as the variable baseStepID (Step 1004).

The flow definition information changing module 112 extracts the step definition information 604 including the id element having the same value as the variable targetStepID from the flow definition information 502, and deletes the step definition information 604 from the flow definition information 502 (Step 1005).

The flow definition information changing module 112 executes Step 1006 of determining whether or not the variable targetStepID is the tail element of the variable stepIDGroup. When the variable targetStepID is the tail element of the variable stepIDGroup (Step 1006: Yes), the step integration processing is brought to an end, and when the variable targetStepID is not the tail element (Step 1006: No), the procedure advances to Step 1003.

According to the above-mentioned processing, it is possible to integrate a plurality of task steps into one web page. The integrated task step has a limitation imposed on a sequence for inputting fields (components) based on a dependence relationship between the fields, which can maintain consistency between the plurality of task steps. For example, in a task flow in which an input to a second field is performed as a second task step after an input to a first field is finished in a first task step, the second field that can be edited is kept inactivated until the input to the first field is completed, to thereby prohibit the input. Then, by adding the event listener to the integrated web page, after the input to the first field is detected, the event listener activates the second field to permit the user to perform the input thereto, which can maintain the consistency between the plurality of task steps within the one web page.

Further, in a case where a plurality of fields use the same value, the fields displaying the duplicate value are detected and deleted from the input/output history information table 530, which can prevent a plurality of same values from being displayed in the integrated task step.

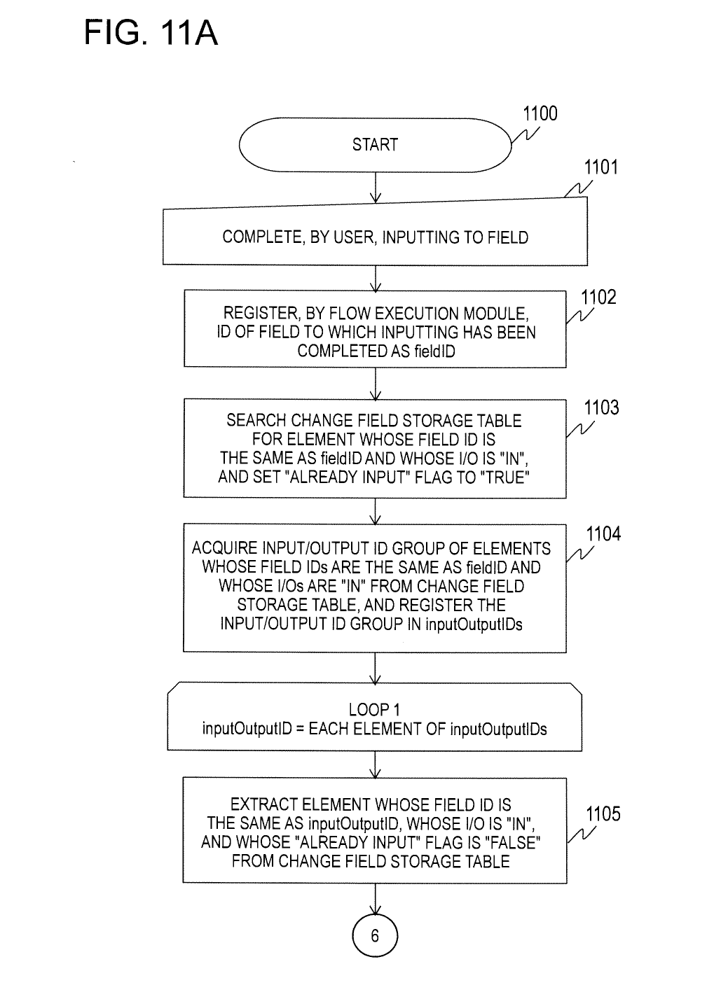

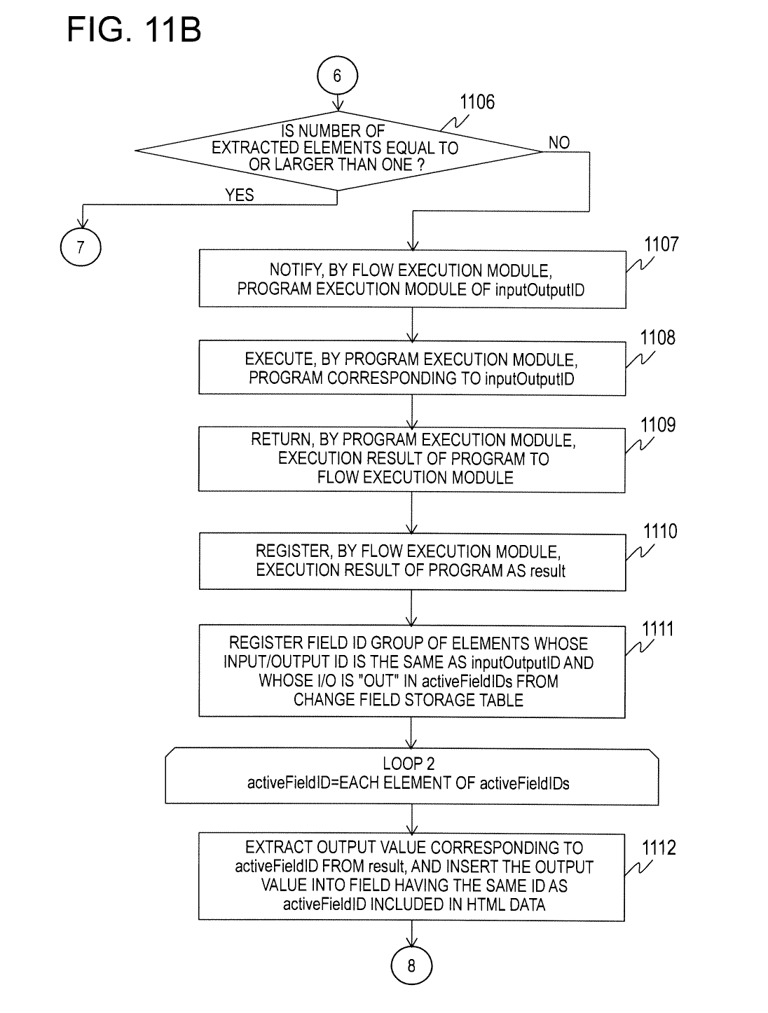

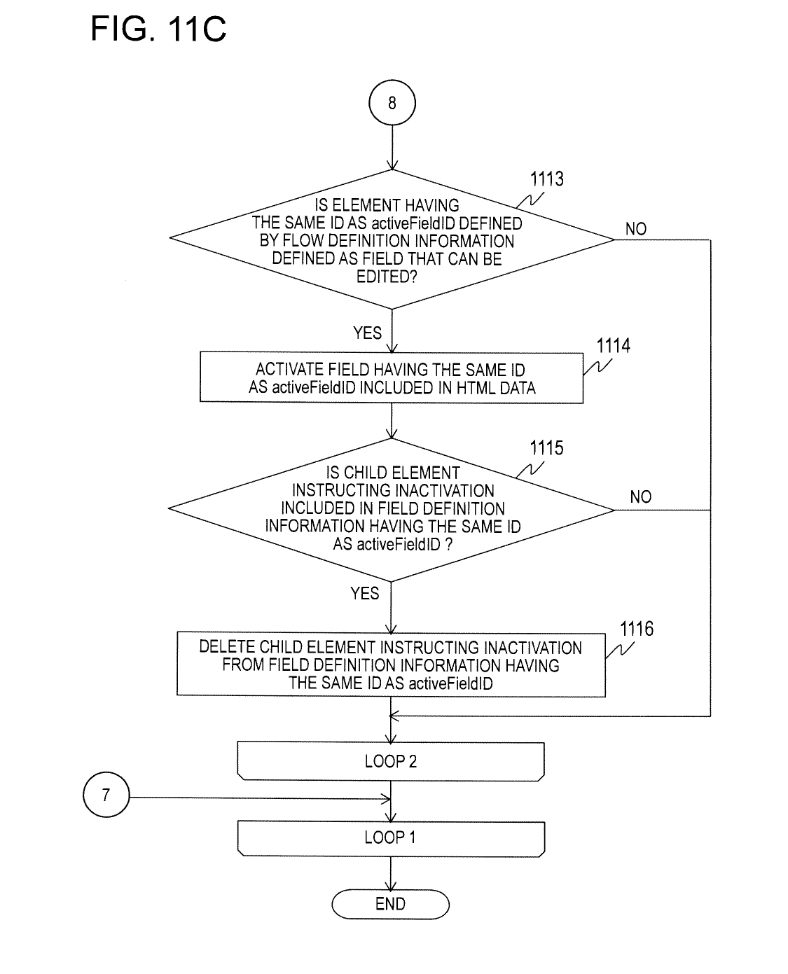

FIGS. 11A, 11B, and 11C are flowcharts illustrating an example of the event listener processing according to this embodiment. This processing is started by the user 400 of the client apparatus 100 performing an input to the integrated task step.

First, when the user 400 uses the input device 104 to perform an input to an input field displayed on the screen of the display device 103, the browser 110 executes Step 1101 of completing reception of the input.

The completion of the input performed by the user 400 is detected by the browser 110, and the flow execution module 111 is called through the event listener defined in the input field. It should be noted that this event listener is given to the task step by the flow definition information changing module 112 in Step 805 of FIG. 8A

In response to the call from the browser 110, the flow execution module 111 registers the ID of the field to which the input has been completed by the user 400 as a variable fieldID (Step 1102). It should be noted that the browser 110 notifies the flow execution module 111 of the ID of the field.

The flow execution module 111 notifies the change field storage module 113 of the field ID, and requests the change field storage module 113 to update the change field storage table 520 (Step 1103). At this time, the change field storage module 113 sets the value of the column 524 to “TRUE” for all the rows in which the value of the column 522 of the change field storage table 520 matches the received field ID with the value of the column 523 being “IN”.

The flow execution module 111 requests the change field storage module 113 to perform a search using the field ID as a key, and registers an input/output ID group received as a result thereof in a array inputOutputIDs (Step 1104). At this time, the change field storage module 113 extracts all the rows in which the value of the column 522 matches the received field ID with the value of the column 523 being “IN”, deletes duplication from the input/output IDs included in the extracted rows, and returns the resultant to the flow execution module 111.

The flow execution module 111 executes the following processing by assuming each element of the array inputOutputIDs as inputOutputID (Loop 1).

The flow execution module 111 requests the change field storage module 113 to perform a search using the value of the variable inputOutputID as a key, and receives the number of corresponding elements (Step 1105). At this time, the change field storage module 113 extracts all the elements in which the value of the column 521 matches the received value of the variable inputOutputID with the value of the column 523 being “IN” and the value of the column 524 being “FALSE” from the change field storage table 520, and notifies the flow execution module 111 of the number of elements.

The flow execution module 111 determines whether or not the number of elements received in Step 1105 is equal to or larger than one (Step 1106). When the number of elements is equal to or larger than one (Step 1106: Yes), the procedure advances to Step 1105 being a start point of Loop 1 by changing the variable inputOutputID to the next element of the array inputOutputIDs, and when the number of elements is zero (Step 1106: No), the procedure advances to Step 1107.

The flow execution module 111 notifies the program execution module 212 of the server apparatus 200 of the variable inputOutputID (Step 1107).

The program execution module 212 executes the program corresponding to the variable inputOutputID (Step 1108). In this embodiment, the program executed by the program execution module 212 in this step is previously registered in association with the variable inputOutputID. The program executed by the program execution module 212 can include execution of an inquiry from a database server (not shown).

The program execution module 212 returns an execution result of the program executed in Step 1108 to the flow execution module 111 (Step 1109).

The flow execution module 111 registers the execution result of the program received from the program execution module 212 as a variable result (Step 1110).

The flow execution module 111 requests the change field storage module 113 to perform a search using the variable inputOutputID as a key, and registers a field ID group received as a result thereof in a preset array activeFieldIDs (Step 1111). At this time, the change field storage module 113 extracts all the rows in which the value of the column 521 matches the received value of the variable inputOutputID with the value of the column 523 being “OUT” from the change field storage table 520, extracts the value of the column 522 from each of the extracted rows, and returns the resultant to the flow execution module 111.

The flow execution module 111 executes the following processing by assuming each element of the array activeFieldIDs as a variable activeFieldID (Loop 2).

The flow execution module 111 extracts all the elements in which the value of the field ID matches the variable activeFieldID from the variable result, and inserts the output data corresponding to the extracted elements as the value of an element in which an id attribute included in the HTML data presented to the user 400 matches the variable activeFieldID (Step 1112).

The flow execution module 111 extracts the field definition information 601 including the id element having a value matching the variable activeFieldID from the flow definition information 502, and determines whether or not the field definition information 601 is to be converted into the field that can be edited in the case of being converted into the HTML data (Step 1113). When the field definition information 601 is to be converted into the field that can be edited (Step 1113: Yes), the procedure advances to Step 1114, and when the field definition information 601 is not to be converted into the field that can be edited (Step 1113: No), the procedure advances to Step 1112 by changing the variable activeFieldID to the next element of the array activeFieldIDs.

The flow execution module 111 extracts the element whose id attribute matches the variable activeFieldID from the HTML data presented to the user 400, and performs activation in a case where the element is inactivated (Step 1114). It should be noted that the inactivation of the HTML element represents effecting a state in which the user cannot edit the HTML element by adding a disable attribute whose value is “true” to the HTML element to effect a state in which no input is received, by disabling the display of the HTML element itself, or by other such method, but is not limited to those methods. Further, the activation of the HTML element represents a method for canceling the above-mentioned inactivation, and corresponds to deleting the disable attribute from the HTML element, canceling the disabled display of the HTML element, or other such method.

The flow execution module 111 extracts the field definition information 601 including the id element having the same value as the variable activeFieldID from the flow definition information 502, and determines whether or not the field definition information 601 includes a child element instructing the inactivation (Step 1115). When the field definition information 601 includes the child element instructing the inactivation (Step 1115: Yes), the procedure advances to Step 1116, and when the field definition information 601 does not include the child element instructing the inactivation (Step 1115: No), the procedure advances to Step 1112 by assuming the variable activeFieldID as the next element of the array activeFieldIDs.

The flow execution module 111 extracts the field definition information 601 including the id element having the same value as the variable activeFieldID from the flow definition information 502, and deletes the child element instructing the inactivation from the field definition information 601 (Step 1116).

The flow execution module 111 executes the above-mentioned processing (Loop 2) on all the elements included in the array activeFieldIDs, further executes the above-mentioned processing (Loop 1) on all the elements included in the array inputOutputIDs, and then brings the event listener processing to an end.

According to the above-mentioned processing, by the event listener added to the integrated task step, it is possible to guarantee a array of the plurality of task steps within the one web page obtained by integrating the plurality of task steps.

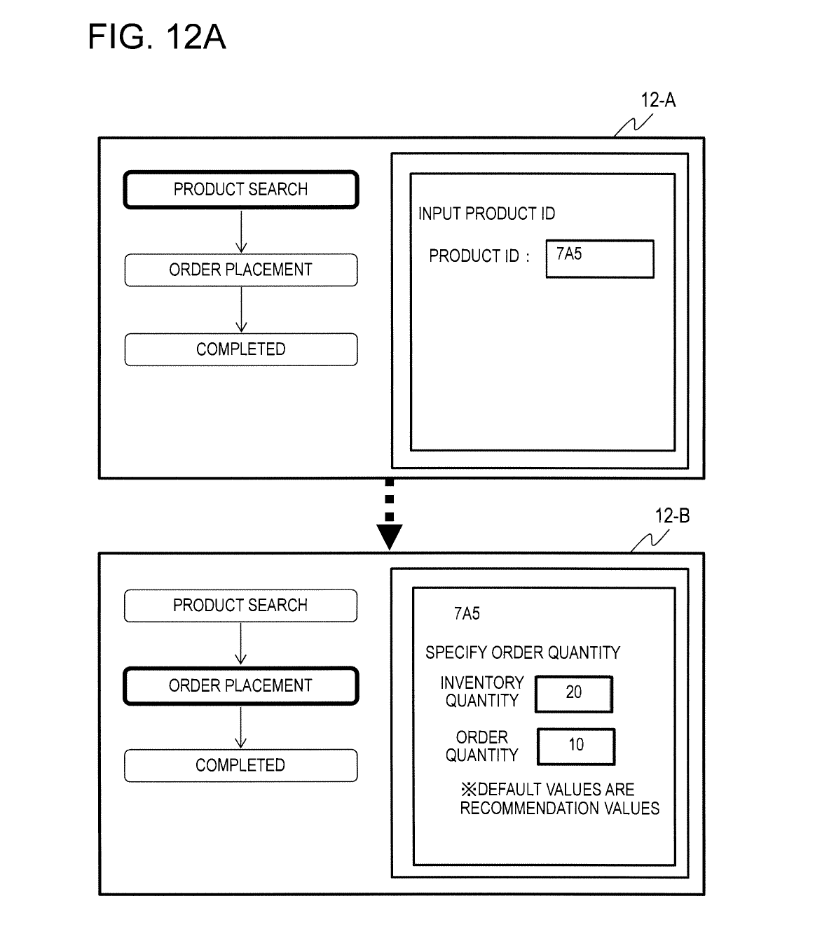

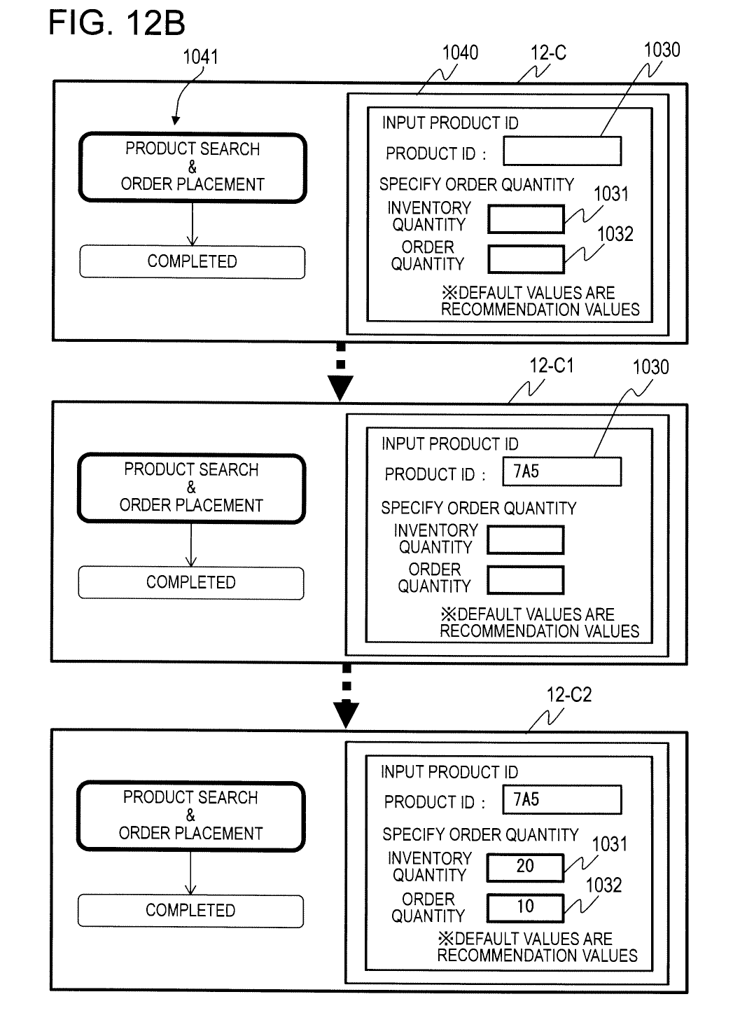

FIG. 12A illustrates a display format of the task flow in a case where the task steps are not integrated, and FIG. 12B illustrates a display format of the task flow in a case where the task steps are integrated.

Screens 12-A and 12-B of FIG. 12A indicate the display format of the task flow before the integration, the screen 12-A showing a web page for the task step of performing, by the user, product search processing, the screen 12-B showing a web page for the task step of carrying out, by the user, order placement processing.

The client apparatus 100 first displays the screen 12-A on the display device 103, and when receiving a product ID from the input device 104, displays the web page for the screen 12-B on the display device 103 by advancing to the order placement processing being the next task step. At this time, the flow execution module 111 and the program execution module 212 are executed on the client apparatus 100 and the server apparatus 200, respectively, to search for an inventory quantity of a product corresponding to the product ID and further calculate an default value of an order quantity. The user confirms the default values of the inventory quantity and the order quantity on the screen 12-B, and then changes the order quantity as necessary to perform the order placement processing. In the task flow of FIG. 12A, the display is switched from the screen 12-A to the screen 12-B, to thereby sequentially execute the plurality of task steps.

The information for integrating the above-mentioned two task steps (web pages) into the one web page is stored in the step integration definition information table 510 for each user, and the client apparatus 100 receives the request to execute the task flow from the user. When the web pages to be output from the request to execute the task flow are the web pages to be integrated, the client apparatus 100 and the server apparatus 200 integrate the above-mentioned task steps and output a screen image illustrated in FIG. 12B. A screen 12-C of FIG. 12B is obtained by integrating the two task steps (web pages) illustrated in FIG. 12A into the one web page (one screen).

The screen 12-C and screens 12-C1 and 12-C2 illustrated in FIG. 12B indicate the display format of the task flow after integrating the task steps into the one web page. The screen 12-C is a screen image obtained when the user instructs to start the task flow.

The screen 12-C is formed of a job information display area 1040 for displaying fields as information necessary to carry out the plurality of task steps and a flow display area 1041 for displaying the task flow indicating the sequence of the task steps formed of a plurality of procedures.

The screen 12-C1 shows a screen image obtained at a moment when the user inputs the product ID. The screen 12-C2 shows a state in which the above-mentioned program is executed based on the user's input with the default values of the inventory quantity and the order quantity being output to the screen 12-C2.

The user first instructs the client apparatus 100 to display the task flow, and the client apparatus 100 displays the screen of the screen 12-C on the display device 103. At this time, the default values within the fields of an inventory quantity 1031 and an order quantity 1032 are determined depending on the field of a product ID 1030, and hence, in the state of the screen 12-C, each of the input items is displayed in the inactivated state.

Subsequently, when the user inputs the product ID 1030, a transition is made to the state of the screen 12-C 1. The user's input is detected by the browser 110, and the flow execution module 111, the program execution module 212, and the event listener are executed. As a result thereof, a transition is made to the state of the screen 12-C2, and the default values of the inventory quantity 1031 and the order quantity 1032 are inserted by the browser 110, while the inactivation of the input item indicating the order quantity is canceled, which enables the user to perform an input to the field of the order quantity 1032.

In this manner, in the case where the task steps in which the default values of the inventory quantity 1031 and the order quantity 1032 are determined depending on the field of the product ID 1030 are integrated, the order quantity 1032 is inactivated to disable the designation before the user inputs the product ID 1030, which can prevent the user from placing an order with a quantity equal to or larger than the inventory quantity 1031.

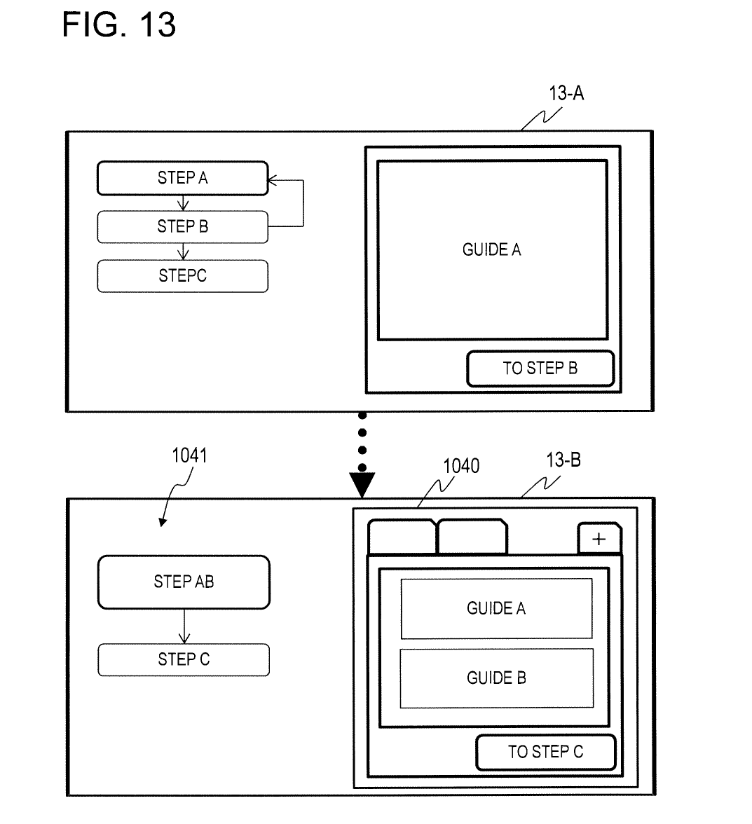

FIG. 13 illustrates an example of an integration screen obtained in a case where the integrated task step includes a repetition definition.

A screen 13-A indicates a display format of the task flow before the integration, and indicates that a task step A and a task step B may be carried out repetitively. A screen 13-B indicates an example of the display format of the task flow in a case where the user instruct to integrate the task step A and the task step B in such a task flow.

On the screen 13-B, a guide A being a guide corresponding to the task step A and a guide B being a guide corresponding to the task step B are displayed on the same screen. In addition, the screen 13-B indicates that a plurality of those guides can be displayed in a tab display. In other words, on the screen 13-B, tabs can be increased based on the repetition within the task flow. The expression of the repetition using the tabs is merely an example, and the expression form is not limited thereto. As illustrated in FIG. 13, by enabling the integrated screen to be displayed a plurality of times, it is possible to integrate the task steps even if the flow includes a repetition.

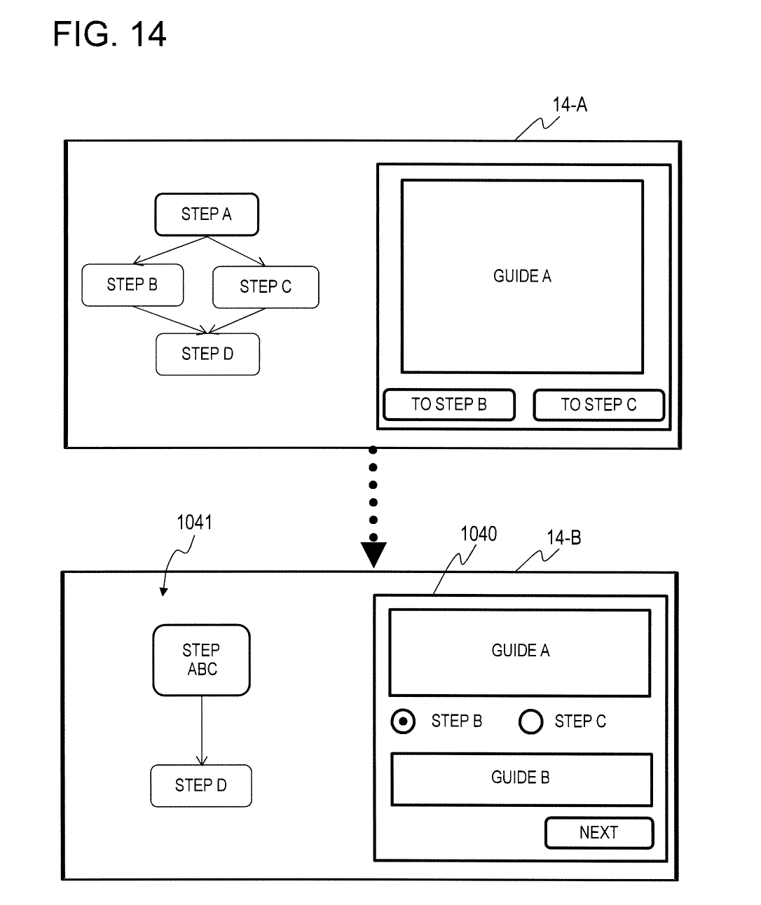

FIG. 14 illustrates an example of an integration screen obtained in a case where the integrated task step includes a condition branch.

A screen 14-A indicates a display format of the task flow before the integration, and indicates that, after the execution of the task step A, the task step B or a task step C is exclusively executed, and then a task step D is executed. A screen 14-B indicates an example of the display format of the task flow in a case where the user instructs to integrate the task step A, the task step B, and the task step C in such a flow.

The screen 14-B obtained by integrating the plurality of task steps indicates that, in addition to the guide A being the guide corresponding to the task step A, a radio button that allow the task step B or the task step C to be exclusively selected is displayed and that, when the execution of the task step B is selected, the guide B being the guide corresponding to the task step B is displayed in addition to the radio button. When the execution of the task step C is selected by the radio button, a guide corresponding to the task step C is output to a display area of the guide B of FIG. 14.

The expression of the instruction to exclusively execute the step by the radio button is merely an example, and the expression form is not limited thereto. As illustrated in FIG. 14, by presenting a selection method for selecting the task step to be exclusively executed to the user, it is possible to integrate the steps even with regard to the flow including a condition branch.

### Second Embodiment

Next, a second embodiment is described with reference to the accompanying drawings.

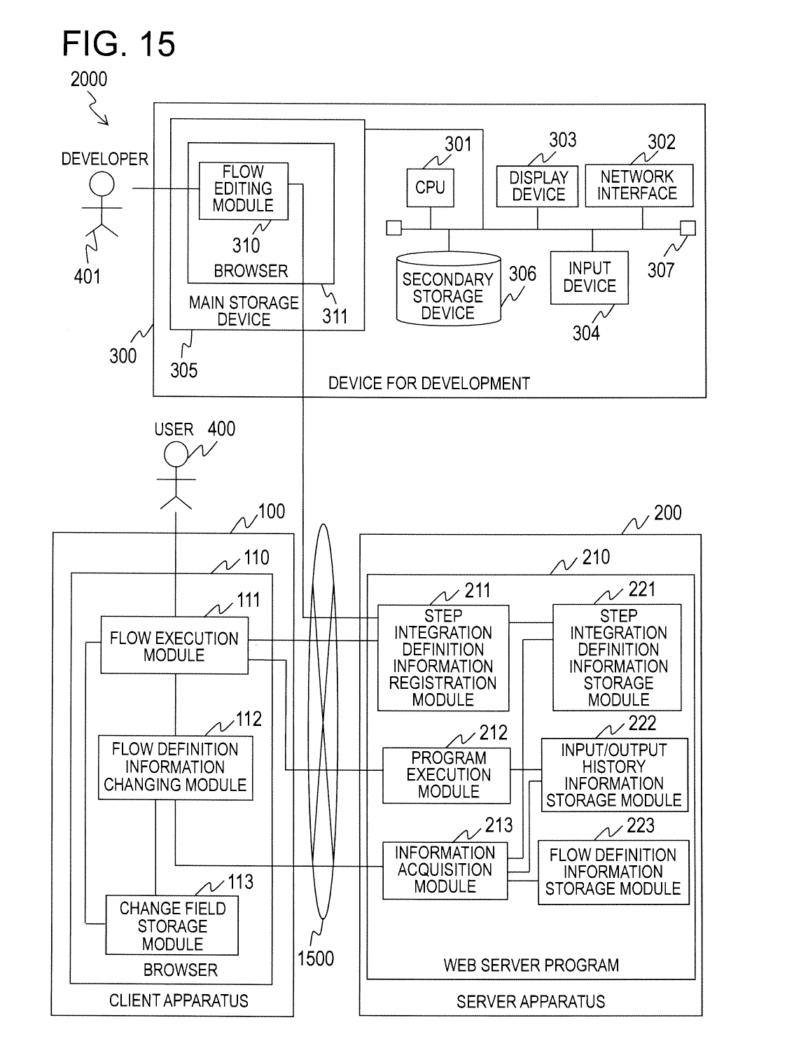

FIG. 15 is a block diagram illustrating outlines of hardware and software of a computer system 2000 according to the second embodiment.

In this embodiment, a device 300 for development which is operated by a developer 401 is disposed in addition to the client apparatus 100 and the server apparatus 200 according to the first embodiment described above.

In the same manner as in the client apparatus 100, the device 300 for development can be realized by a general-purpose computer, and includes a CPU 301, a network interface 302, a display device 303, an input device 304, a main storage device 305, a secondary storage device 306, and a system bus 307 for coupling those components to one another. Individual hardware functions thereof are the same as those of the client apparatus 100, and hence detailed descriptions thereof are omitted.

The program stored on the main storage device 305 of the device 300 for development is also a browser 311 having the same functions as that of the client apparatus 100, but is different from that of the client apparatus 100 in that the program executed on the browser 311 is a flow editing module 310.

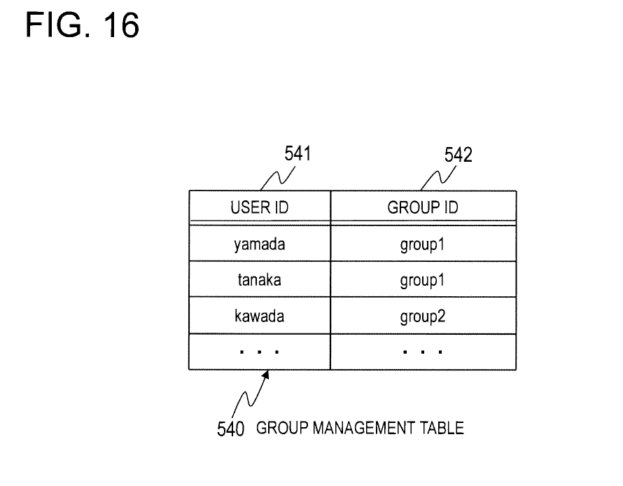

FIG. 16 illustrates an example of a structure of a group management table 540 used by the flow editing module 310 of the device 300 for development. The group management table 540 is formed of a column 541 for storing the user ID and a column 542 for storing a group ID. The group management table 540 indicates that the user that can be uniquely identified by the user ID stored in the user column 541 belongs to a group that can be uniquely identified by the group ID stored in the column 542. Herein, the group is defined as a set of at least one user for collective management thereof.

Specifically, it is indicated that the user that can be identified by the user ID of “yamada” and the user having the user ID of “tanaka” belong to the group that can be identified by the group ID of “group1”, and the user that can be identified by the user ID of “kawada” belongs to the group that can be identified by the group ID of “group2”.

It should be noted that the expression of the data structure using the table is merely an example, and does not limit expressions using other data structures.

This embodiment provides a method of managing the step integration definition information 513, which is managed for each user by using the step integration definition information table 510 in the first embodiment described above, for each group, in other words, by collectively managing the integration definitions of the steps for a plurality of users. This can be realized as follows. In other words, in Step 705 of FIG. 7A described above, before the step integration definition information storage module 221 searches the step integration definition information table 510 by using the user ID as a key, the step integration definition information storage module 221 searches the group management table 540 by using the user ID as a key. Then, the step integration definition information storage module 221 converts the user ID into the group ID by extracting the value of the column 542 of the row whose column 541 has a value matching the user ID from the group management table 540 as the group ID, and searches the step integration definition information table 510 by using the group ID as a key.

It should be noted that a mapping definition between the user ID and the group ID and the step integration definition information for the group are registered by notifying, by the developer 401, the flow editing module 310 of the group ID, the flow ID, and the set of the step IDs to be integrated, notifying the step integration definition information registration module 211 of the information received by the flow editing module 310, requesting, by the step integration definition information registration module 211, the step integration definition information storage module 221 to store the information, and storing, by the step integration definition information storage module 221, the information in the step integration definition information table 510.

In this embodiment, by providing the developer 401 with a method of defining the step integration definition information for the group, for example, in a case where there exist a large number of users who perform the same task on a department-to-department basis of a company, it is possible to provide the large number of users with a flow obtained by the collective integration, which can alleviate job load on a developer.

### Third Embodiment

Next, a third embodiment is described with reference to the accompanying drawings.

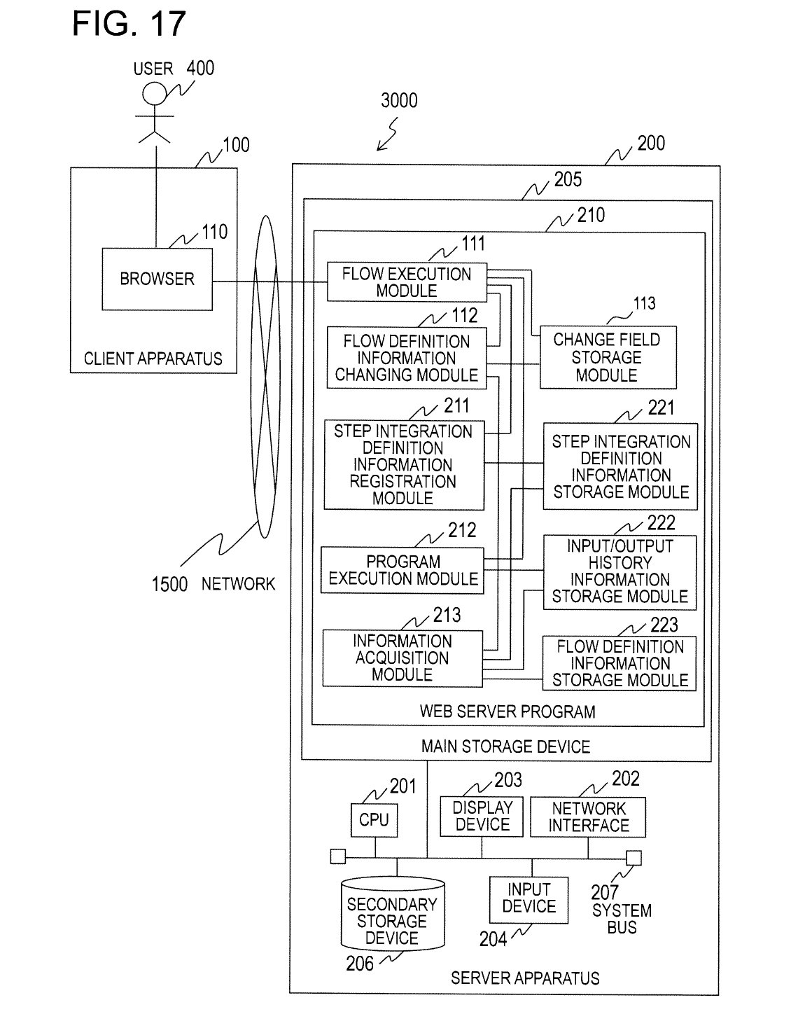

FIG. 17 is a block diagram illustrating an outline of hardware and software of a computer system 3000 according to the third embodiment. In this embodiment, the flow execution module 111, the flow definition information changing module 112, and the change field storage module 113 that are disposed in the browser 110 of the client apparatus 100 in the first embodiment described above are disposed in the web server program 210 of the server apparatus 200. The other components are the same as those of the first embodiment described above.

In this embodiment, the browser 110 transmits the HTTP request to the server apparatus 200 based on the request made by the user 400, the web server program 210, which has been received the request, executes processing for changing the flow definition information 502 through the flow execution module 111, the flow definition information changing module 112, and the change field storage module 113 that are disposed in the web server program 210 and processing for generating the HTML data based on the flow definition information 502 and returns a response, and the browser 110 displays the HTML data.

With this embodiment, the client apparatus 100 only needs to execute processing for transmitting the HTTP request in response to the request made by the user and processing for displaying the HTML data received from the flow execution module 111, which can alleviate load on the client apparatus 100. The other points are the same as those of the first embodiment described above, and it is possible to integrate the plurality of task steps into the one web page.

This invention can be applied to a computer system using a web browser to perform a task, a web browser, and a program for a web server.

What is claimed is:

1. A web page control method of integrating, by a computer, a plurality of web pages and outputting the plurality of web pages as a single web page, the web page control method comprising:
a first step of acquiring, by the computer, integration definition information for defining the plurality of web pages to be integrated into the single web page;
a second step of extracting, by the computer, an input/output relationship between components comprised in the plurality of web pages of the integration definition information;
a third step of extracting, by the computer, a component of the web page being an output destination from the extracted input/output relationship;
a fourth step of prohibiting, by the computer, an operation from being performed on the extracted component of the web page being the output destination;
a fifth step of extracting, by the computer, all components of the web page being input sources from the extracted input/output relationship; and
a sixth step of permitting, by the computer, the operation to be performed on the component of the web page being the output destination when the operation has been completed on all the components of the web page being the input sources.

2. The web page control method according to claim 1, further comprising:
a seventh step of referring, by the computer, to operation procedure definition information in which the component which is set for each of the plurality of web pages and an operation sequence of the plurality of web pages are set in advance; and
an eighth step of outputting, by the computer, the web page comprising a procedure display area for displaying the operation sequence of the plurality of web pages from the operation procedure definition information on the plurality of web pages to be integrated, and a single job information display area obtained by integrating the components which are set for the plurality of web pages.

3. The web page control method according to claim 1, wherein the fourth step comprises realizing prohibition of the operation by inactivating the extracted component of the web page being the output destination.

4. The web page control method according to claim 1, wherein the fourth step comprises realizing prohibition of the operation by disabling display of the extracted component of the web page being the output destination.

5. The web page control method according to claim 2, further comprising a step of retaining, by the computer, history information in which a value input to the component of the web page being the input source of the input/output relationship and a value output to the component of the web page being the output destination thereof are stored in association with each other among the components which are set in the operation procedure definition information,
wherein the eighth step comprises the steps of:
extracting the history information regarding the input/output relationship between the components of the plurality of web pages to be integrated which are comprised in the job information display area;
comparing the value input to the component of the web page being the input source of the input/output relationship with the corresponding value output to the component of the web page being the output destination of the input/output relationship based on the extracted history information; and
deleting the component of the web page being the output destination for which comparison results thereof are constantly the same.

6. The web page control method according to claim 2, wherein the eighth step comprises the steps of:
extracting repetition information comprised in a sequence of tasks of the plurality of web pages to be integrated from the operation procedure definition information; and
displaying a plurality of the job information display areas based on repetition so as to correspond to the sequence of the tasks comprised in the extracted repetition information.

7. The web page control method according to claim 2, wherein the eighth step comprises the steps of:
extracting a condition branch comprised in a sequence of tasks of the plurality of web pages to be integrated from the operation procedure definition information;
adding information for selecting the task to be exclusively executed in the extracted condition branch to the job information display area; and
outputting only the component necessary to carry out the task to the job information display area obtained by the integration from the information for selecting the task.

8. The web page control method according to claim 2, wherein the operation procedure definition information comprises input/output definition information for defining the input/output relationship between the components comprised in the plurality of web pages and web page definition information for defining the components of the web page.

9. A computer system for integrating a plurality of web pages and outputting the plurality of web pages as a single web page, the computer system comprising:
a server apparatus comprising:
an integration definition information storage module for storing integration definition information for defining the plurality of web pages to be integrated and output within the single web page;
an input/output definition information storage module for storing input/output definition information for defining an input/output relationship between components comprised in the plurality of web pages; and
a web page definition information storage module for storing web page definition information for defining the component of the web page; and
a client apparatus comprising:
a definition information changing module for receiving the integration definition information, the input/output definition information, and the web page definition information from the server apparatus, extracting the plurality of web pages to be integrated from the received integration definition information, and changing the web page definition information in order to prohibit an operation from being performed on the component of the web page being an output destination comprised in the received input/output definition information, the component being the extracted component comprised in the plurality of web pages to be integrated;
a change storage module for storing a state of the operation performed on the component of the web page being an input source defined in the input/output definition information in association with the component of the web page that stores an output result defined in the input/output definition information; and
an execution module for displaying the web page on a display device based on the changed web page definition information acquired from the definition information changing module, extracting the component of the web page that stores the output result corresponding to the component on which the operation has been completed and all components being the input sources corresponding to the component of the web page that stores the extracted output result among the components stored in the change storage module when it is detected that the operation has been completed on the component comprised in the displayed web page, and when all the extracted components being the input sources have already been operated, permitting the operation to be performed on the component of the web page being the output destination.

10. The computer system according to claim 9, wherein:
the web page definition information comprises operation procedure definition information in which the component which is set for each of the plurality of web pages and an operation array of the plurality of web pages are set in advance; and
the execution module refers to the integration definition information to output the web page comprising a procedure display area for displaying a task flow indicating a array of a plurality of tasks from a plurality of pieces of the web page definition information to be integrated, and a single job information display area obtained by integrating the components which are set for the plurality of web pages.

11. The computer system according to claim 9, wherein the definition information changing module prohibits the operation by inactivating the extracted component of the web page being the output destination.

12. The computer system according to claim 9, wherein the definition information changing module prohibits the operation by disabling display of the extracted component of the web page being the output destination.

13. The computer system according to claim 10, wherein:
the change storage module retains history information in which a value input to the component of the web page being the input source defined in the input/output definition information and a value output to the component of the web page being the output destination thereof are stored in association with each other; and
the definition information changing module extracts the history information regarding the input/output relationship between the components of the plurality of web pages to be integrated which are comprised in the job information display area, compares the value input to the component of the web page being the input source of the input/output relationship with the corresponding value output to the component of the web page being the output destination of the input/output relationship based on the extracted history information, and deletes the component of the web page being the output destination for which comparison results thereof are constantly the same.

14. The computer system according to claim 10, wherein:
the definition information changing module extracts repetition information comprised in a sequence of tasks of the plurality of web pages to be integrated from the operation procedure definition information; and
the execution module displays a plurality of the job information display areas based on repetition so as to correspond to the sequence of the tasks comprised in the repetition information extracted by definition information changing module.

15. The computer system according to claim 10, wherein:
the definition information changing module extracts a condition branch comprised in a sequence of tasks of the plurality of web pages to be integrated from the operation procedure definition information, and adds information for selecting the task to be exclusively executed in the extracted condition branch to the job information display area; and
the execution module outputs only the component necessary to carry out the task to the job information display area obtained by the integration from the information for selecting the task.

16. The computer system according to claim 10, wherein the operation procedure definition information comprises input/output definition information for defining the input/output relationship between the components comprised in the plurality of web pages and web page definition information for defining the components of the web page.

17. A program for controlling a computer to execute processing for integrating a plurality of web pages and outputting the plurality of web pages as a single web page, the program controlling the computer to execute:
a first procedure of acquiring integration definition information for defining the plurality of web pages to be integrated into the single web page;
a second procedure of extracting an input/output relationship between components comprised in the plurality of web pages of the integration definition information;
a third procedure of extracting a component of the web page being an output destination from the extracted input/output relationship;
a fourth procedure of prohibiting an operation from being performed on the extracted component of the web page being the output destination;
a fifth procedure of extracting all components of the web page being input sources from the extracted input/output relationship; and
a sixth procedure of permitting the operation to be performed on the component of the web page being the output destination when the operation has been completed on all the components of the web page being the input sources.

18. The program according to claim 17, further comprising:
a seventh procedure of referring to operation procedure definition information in which the component which is set for each of the plurality of web pages and an operation sequence of the plurality of web pages are set in advance; and
an eighth procedure of outputting the web page comprising a procedure display area for displaying the operation sequence of the web pages of a plurality of tasks from the operation procedure definition information on the plurality of web pages to be integrated, and a single job information display area obtained by integrating the components which are set for the plurality of web pages.

19. The program according to claim 18, further comprising a procedure of retaining history information in which a value input to the component of the web page being the input source of the input/output relationship and a value output to the component of the web page being the output destination thereof are stored in association with each other among the components which are set in the operation procedure definition information,
wherein the eighth procedure comprises:
a procedure of extracting the history information regarding the input/output relationship between the components of the plurality of web pages to be integrated which are comprised in the job information display area;
a procedure of comparing the value input to the component of the web page being the input source of the input/output relationship with the corresponding value output to the component of the web page being the output destination of the input/output relationship based on the extracted history information; and
a procedure of deleting the component of the web page being the output destination for which comparison results thereof are constantly the same.
